(19) United States
(12) Patent Application Publication
(10) Pub. No.: US 2011/0085448 A1
(43) Pub. Date: Apr. 14, 2011

(54) WIRELESS COMMUNICATION SYSTEM, WIRELESS BASE STATION APPARATUS, AND WIRELESS COMMUNICATION METHOD

(76) Inventor: Mikio KUWAHARA, Yokohama (JP)

(21) Appl. No.: 12/898,894

(22) Filed: Oct. 6, 2010

(30) Foreign Application Priority Data
Oct. 13, 2009 (JP) 2009-236516

(51) Int. Cl. H04W 72/04; H04L 12/26

(52) U.S. Cl. 370/242; 370/329

(57) ABSTRACT

Random beams and FFR are used in combination, frequencies are grouped into a zone associated with the center of a cell and a zone associated with the border of the cell, and the random beams are applied only to the zone associated with the border of the cell. Since the number of resources to be allocated to the random beams decreases, a terminal lying on the border of the cell can reduce overhead. Using the zone associated with the center of the cell, beam scheduling can be freely performed within the cell.

### CLAIM OF PRIORITY

The present application claims priority from Japanese patent application JP 2009-236516 filed on Oct. 13, 2009, the content of which is hereby incorporated by reference into this application.

### BACKGROUND OF THE INVENTION

1. Field of the Invention

The present invention relates to a wireless communication system, a wireless base station device, and a wireless communication method. In particular, the present invention is concerned with a wireless communication system of a cellular type or the like having a mechanism of alleviating an effect of interference even in a border area between base stations in a case where the quality of a signal may be degraded due to interference of signals, transmitted from the plural base stations, with each other.

2. Description of the Related Art

### 1. Cellular Communication

In mobile wireless communication, since a moving terminal and a base station communicates with each other within a service area that spreads as a plane, a cellular scheme is generally adopted. In the cellular scheme, plural base stations are scattered within the service area, and areas to be covered by the respective base stations (areas in which terminals are communicative) are linked in order to realize a planar cover area. Each base station transmits a reference signal with which the own station is identified. The reference signal is designed to be unique to each base station in a region by devising a signal sequence to be transmitted, a time of transmission, a frequency, or a combination of the signal sequence, time, and frequency. A terminal receives the unique reference signals transmitted from the respective base stations, measures the signal intensities, compares the signal intensities with one another, and thus grasps the wireless states of the own station relative to neighboring base stations. The results of measurement of the wireless states are utilized in order to search for the base station which gives a signal of stronger intensity and offers an excellent receiving state (a propagation distance is presumably the shortest). If a decision is made that the base station which offers the excellent receiving state has changed from the base station, to which the terminal is currently connected, to any other neighboring base station, handover of switching connections to select the connection to the base station which is expected to offer a superb receiving state is carried out in order to implement cellular communication.

FIG. 1 is a diagram showing a topology of a wireless communication system.

Referring to FIG. 1, the concept of cellular communication will be re-described below. In cellular communication, as shown in FIG. 1, plural base stations (20, 21, and 22) are present. A terminal 1 wirelessly communicates with the base station 20. The base stations are connected to a network device 50, whereby wired communication paths are ensured. The network device 50 connected to the base stations is IP-connected via a packet switching device 40. In the drawing, the terminal 1 is communicating with the base station 20 which is located at the nearest distance and from which an excellent signal can be received. The base stations (20, 21, and 22) are transmitting reference signals that are unique identification signals. The terminal 1 receives the reference signals transmitted from the respective base stations, and measures the receiving signal intensities. The terminal recognizes the base station whose reference signal has the strongest receiving intensity as the base station located at the nearest distance. In the drawing, a downlink signal 30 (communication from the base station to the terminal) and an uplink signal 31 (communication from the terminal to the base station) are shown. The base station 20 is transmitting the downlink signal 30, the base station 21 is transmitting a downlink signal 32, and the base station 22 is transmitting a downlink signal 33. Since the signals are transmitted at the same frequency at the same time, the downlink signals 30, 32, and 33 interfere with one another. The terminal 1 located on the border of a cell receives the desired signal 30 from the base station 20, receives the interference waves 32 and 33 from the other stations at the same time, and undergoes the effect of the interference waves. The ratio of interference power and noise power to desired signal power is called a signal interference and noise power ratio (SINR). On the border of the cell, interferences from the other cells grow, and become a dominant item in the denominator. The SINR is therefore degraded. Eventually, information communication at a high throughput becomes hard to do.

### 2. Fractional Frequency Reuse (FFR)

As a method of reducing interference on a border of a cell, fractional frequency reuse (FFR) is known (refer to patent document 1 (“Base Station” of JP-A-2009-21787), patent document 2 (“Wireless Communication System” of JP-A-2009-44397), non-patent document 1 (“6.3.2 Radio resource control information elements” in 3GPP TS36.331), non-patent document 2 (“4.2 Fractional Frequency Reuse” in “A Technical Overview Performance Evaluation” in Mobile WiMAX-Part I), non-patent document 3 (“20.1 Interference Mitigation using Fractional Frequency Reuse” in IEEE 802.16m “System Description Document” (IEEE 802.16m-08/003r7)), or non-patent document 5 (“5.2 Downlink power allocation” in 3GPP TS36.213). FFR is implemented in a multiplexing scheme suitable for broadband communication such as orthogonal frequency division multiplexing access (OFDMA). In the FFR, whether a terminal is located on a border of a cell or located in the center of the cell is grasped, and a frequency to be allocated is restricted depending on the location. In addition, transmission power is varied depending on the frequency to be allocated. Allocation is controlled for fear frequencies to be used by terminals located on borders of neighboring cells may be identical to each other. Interference is controlled in the frequency domain.

FIG. 2 shows a frequency utilization method for three base stations adopting the FFR. There are three base stations 20, 21, and 22. The axis of abscissas indicates frequencies, and the axis of ordinates indicates signal powers transmitted at the respective frequencies. In a frequency band 60, the three base stations transmit signals with feeble transmission power. Since all the base stations transmit signals at a specific frequency in the frequency band, the reuse rate of the frequency is 1. In this case, it may be said that reuse level 1 is attained. The frequency band 60 is allocated to terminals located in the center of a cell (terminals distributed near the base station). Since utilizing entities are the terminals located in the center of the cell, even if a transmission output is feeble, a propagation loss suffered by a signal transmitted from a desired base station is limited and the signal is received with high power. Since an interference wave sent from a neighboring base station propagates a longer propagation distance than a desired wave does, the interference wave suffers a larger propagation loss than the desired wave does. Therefore, the desired wave hardly undergoes an effect of the interference wave. Eventually, excellent signal quality is likely to be attained.

In frequency bands 61, 62, and 63, the three base stations transmit signals at their designated frequencies alone but do not transmit signals at any other frequencies. As shown in the drawing, when the reuse rate is 3, it may be said that reuse level 3 is attained. The frequency bands are allocated to terminals located on borders of cells. Since utilizing entities are the terminals located on the borders of the cells, the terminals are likely to receive interference waves from the neighboring cells. As mentioned above, since three different frequencies are repeatedly reused in the neighboring cells, that is, since reuse level 3 is attained, the terminals hardly undergo effects of the interference waves.

In cellular communication, one base station has a directional antenna, and cells are often defined in, for example, three directions. In this case, the three cells supported by the one base station may be regarded as three cells that transmit different reference signals. FIG. 3 shows an example of cellular communication in which one cell includes three sectors. Each of seven base stations 20, 21, 22, 23, 24, 25, and 26 supports three sectors. The sectors have FFR implemented therein. The base station 20 supports three sectors of a sector composed of areas 100 and 103, a sector composed of areas 101 and 104, and a sector composed of areas 102 and 105. A frequency in the frequency band 60 shown in FIG. 2 is allocated to terminals located in the areas 100, 101, and 102 in the center of a cell. A frequency in the frequency band 61 is allocated to terminals located in the area 103. A frequency in the frequency band 62 is allocated to terminals located in the area 104. A frequency in the frequency band 63 is allocated to terminals located in the area 105. Even for the neighboring base station 21, a frequency in the frequency band 60 shown in FIG. 2 is allocated to terminals located in areas 110, 111, and 112 in the center of a cell. A frequency in the frequency band 61 is allocated to terminals located in an area 113. A frequency in the frequency band 62 is allocated to terminals located in an area 114. A frequency in the frequency band 63 is allocated to terminals located in an area 115. Likewise, for the neighboring base station 22, a frequency in the frequency band 60 shown in FIG. 2 is allocated to terminals located in areas 120, 121, and 122 in the center of a cell. A frequency in the frequency band 61 is allocated to terminals located in an area 123. A frequency in the frequency band 62 is allocated to terminals located in an area 124. A frequency in the frequency band 63 is allocated to terminals located in an area 125.

On the borders of the areas 103, 115, and 124, a frequency in the frequency band 61 is utilized in the area 103, a frequency in the frequency band 63 is utilized in the area 115, and a frequency in the frequency band 62 is utilized in the area 124. Therefore, the same frequency is not utilized among the neighboring base stations. Eventually, an effect of interference is drastically reduced.

### 3. Fractional Transmission Power Control (FTPC)

In orthogonal frequency division multiplexing access (OFDMA), fast Fourier transform (FFT) is used to split a frequency band into subcarrier bands. Each base station allows a specific terminal to occupy a sub-channel, into which plural subcarrier bands are integrated (may be called a resource block), through scheduling, and communicates with the terminal (the sub-channel may include one or plural resource blocks). Therefore, among terminals belonging to the same cell, only one terminal can use a certain frequency (or a sub-channel or resource block). In principle, interference derived from use of the same sub-channel does not take place. This is a difference from a code division multiple access (CDMA) technology. FIG. 4 is a conceptual diagram.

FIG. 4 is a diagram for use in explaining interference occurring when OFDMA is implemented. In the drawing, there are base stations 20 and 22, and terminals 4 and 5 belong to the same sector. A terminal 3 is connected to the same base station as the terminals 4 and 5 are, but belongs to a neighboring sector. A terminal 2 belongs to a sector supported by a neighboring base station. Assuming that the terminal 4 uplinks a signal, the base station 20 instructs the terminal 4 in advance to use a certain sub-channel usable by the terminal 4. The terminal 5 is instructed to use another sub-channel. Therefore, the terminals 4 and 5 may transmit signals at the same time. However, since the frequencies the terminals utilize for communications are different from each other, the signals sent from the two terminals will not interfere with each other. In contrast, since the terminals 2 and 3 are terminals belonging to a sector and a cell different from the terminals 4 and 5 do, the terminals may uplink signals using the same sub-channels as the terminals 4 and 5 do. Therefore, in this case, interference occurs. As mentioned above, interference in uplink communication does not occur between the terminals belonging to the same sector, but interference occurs between terminals located in different cells or sectors.

A terminal located in the center of a cell need not transmit a signal with high transmission power because it is located at a near distance from a base station with which the terminal communicates. Even when the terminal transmits a signal to a neighboring cell at a far distance with high transmission power, interference affecting any other cell is limited. In contrast, a terminal located on a border of a cell has to transmit a signal with high transmission power because it is located at a far distance from a base station with which the terminal communicates. The distance of the terminal to a neighboring station is near, and interference affecting another cell is intense.

Therefore, in a system adopting OFDMA, even when power to be received at a base station is set to a bit higher level in a terminal located close to the base station, it hardly influences interference. Therefore, a method of controlling transmission power according to an estimated propagation loss so that receiving power at a base-station receiving end gets larger is adopted (refer to non-patent document 4 (“5.1 Uplink power control” in 3GPP TS36.213). It is called FTPC.

### 4. Interference Control Through Beam Forming

Patent document 3 (“Wireless Communication Method and Wireless Base Station Device” of JP-A-2007-243258) and non-patent document 6 (3GPP R1-081827) have disclosed a method of avoiding interference in which: a base station that performs beam forming changes beam patterns according to a frequency, and randomizes interference, which occurs between neighboring stations, in the frequency domain; each terminal reports a situation of interference at its own frequency to the base station; and the base station performs scheduling of frequency allocation with interference avoided.

In either of the documents, selection of beam forming is realized over a given system bandwidth, and combination with FFR is not taken into consideration.

### SUMMARY OF THE INVENTION

As introduced in Description of the Related Art, a technology of introducing FFR for the purpose of avoiding interference is known in cellular communication based on OFDMA. It is also known that FTPC is implemented in order to avoid uplink interference. A method of randomizing selection of a beam to be transmitted according to a frequency, instructing a terminal to report a situation of interference occurring at each frequency, and avoiding interference on the basis of the information is also known. However, in the related arts, randomizing interference through beam forming is implemented over a given system bandwidth, but combination thereof with FFR is not taken into consideration. When FTPC is implemented, an uplink throughput may decrease on a border of a cell. On the border of a cell, rich channel information has to be reported in order to alleviate inter-cell interference. As mentioned above, since the uplink throughput may decrease on the border of a cell, a mechanism for reducing overhead is necessary.

In the related art of reducing inter-cell interference through beam randomization, when a distribution of terminals congested in a specific direction takes place, since a beam pattern is nearly fixed, it is hard to freely change beam scheduling. Efficiency may be degraded.

In a method of avoiding interference by performing, as collaboration of base stations with each other, beam forming and randomization of beam scheduling, since beams in an entire bandwidth are randomized, overhead of control information that should be reported on an uplink is large.

Accordingly, an object of the present invention is to alleviate an effect of interference through collaboration of plural wireless base stations with one another even in a border area between base stations in which signal quality may be degraded because of interference of signals, which are sent from the base stations, with one another.

Another object of the present invention is to alleviate an effect of interference through collaboration of plural wireless base stations with one another even in a border area between base stations.

According to the first solving means of this invention, there is provided a wireless communication system including a plurality of base stations that transmit a plurality of beams with which a space is divided, wherein:

the base station splits a transmission frequency band into a first frequency band and a second frequency band;

in the first frequency band, the base station allocates beams to sub-channels or resource blocks, into which the first frequency band is further split, with the beams fixed to any pattern, on the basis of a beam schedule specifying a plurality of predetermined beams in association with each base station, and transmits signals; and

in the second frequency band, the base station allocates the beams to sub-channels or resource blocks, into which the second frequency band is further split, with the beams fixed to any pattern, on the basis of a beam schedule defined in accordance with communication traffic, and transmits signals.

According to the second solving means of this invention, there is provided a wireless base station apparatus in a wireless communication system, the wireless base station apparatus which transmits a plurality of beams with which a space is divided, wherein:

the wireless base station apparatus splits a transmission frequency band into a first frequency band and a second frequency band;

in the first frequency band, the wireless base station apparatus allocates beams to sub-channels or resource blocks, into which the first frequency band is further split, with the beams fixed to any pattern, on the basis of a beam schedule specifying a plurality of predetermined beams in association with each base station, and transmits signals; and

in the second frequency band, the wireless base station apparatus allocates the beams to sub-channels or resource blocks, into which the second frequency band is further split, with the beams fixed to any pattern, on the basis of a beam schedule defined in accordance with communication traffic, and transmits signals.

According to the third solving means of this invention, there is provided a wireless communication method for a wireless communication system including a plurality of base stations that transmit a plurality of beams with which a space is divided, wherein:

the base station splits a transmission frequency band into a first frequency band and a second frequency band;

in the first frequency band, the base station allocates beams to sub-channels or resource blocks, into which the first frequency band is further split, with the beams fixed to any pattern, on the basis of a beam schedule specifying a plurality of predetermined beams in association with each base station, and transmits signals; and

in the second frequency band, the base station allocates the beams to sub-channels or resource blocks, into which the second frequency band is further split, with the beams fixed to any pattern, on the basis of a beam schedule defined in accordance with communication traffic, and transmits signals.

According to the present invention, avoidance of interference through beam forming for which plural wireless base stations collaborate with one another, and the FFR technology are combined. This is effective in suppressing an increase in overhead on an uplink in a border of a cell which becomes a problem in implementation of FTPC.

### BRIEF DESCRIPTION OF THE DRAWINGS

FIG. 1 is a diagram showing a topology of a wireless communication system;

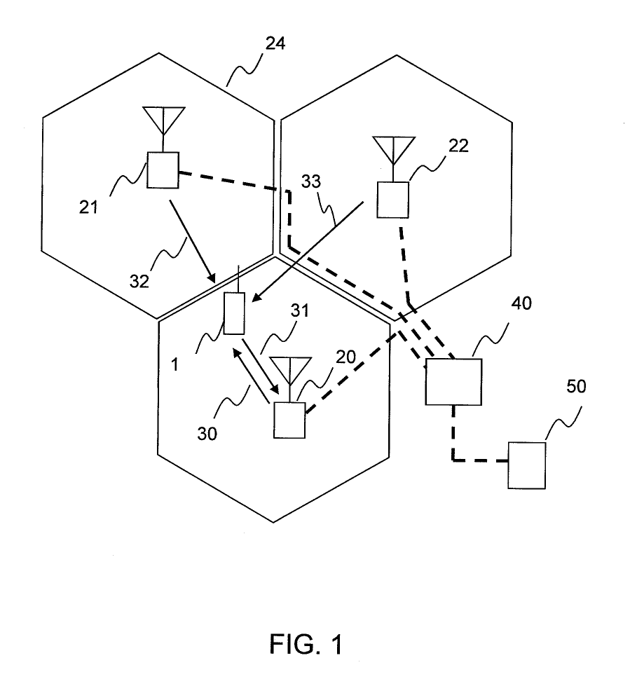

FIG. 2 is an explanatory diagram showing an example of a power profile in a case where FFR is implemented in order to control inter-cell interference;

FIG. 3 is a diagram showing regional utilization of frequencies in a case where FFR is implemented;

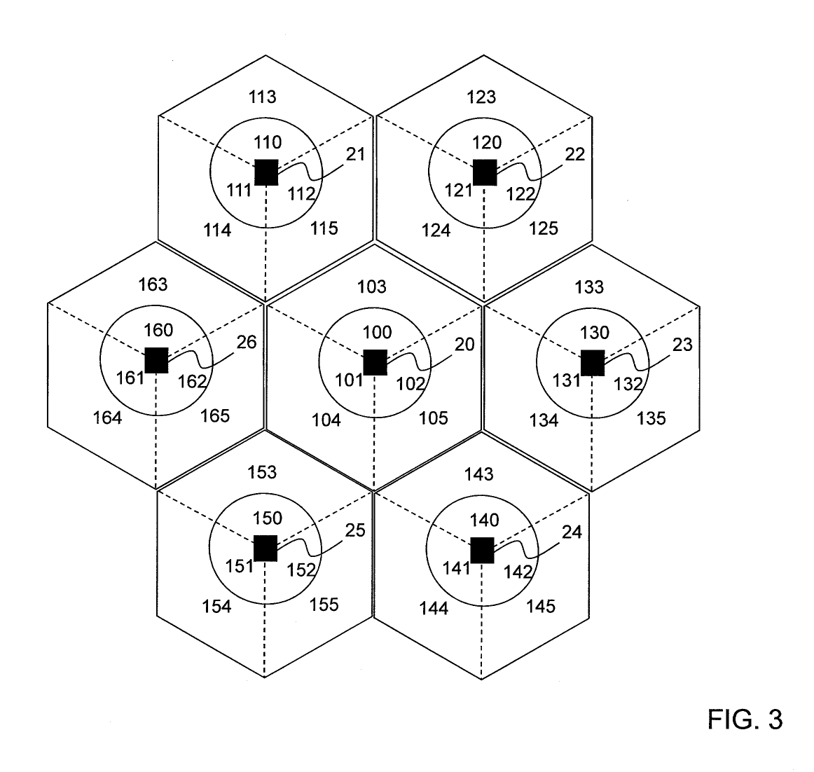

FIG. 4 is a diagram for use in explaining interference occurring when OFDMA is implemented;

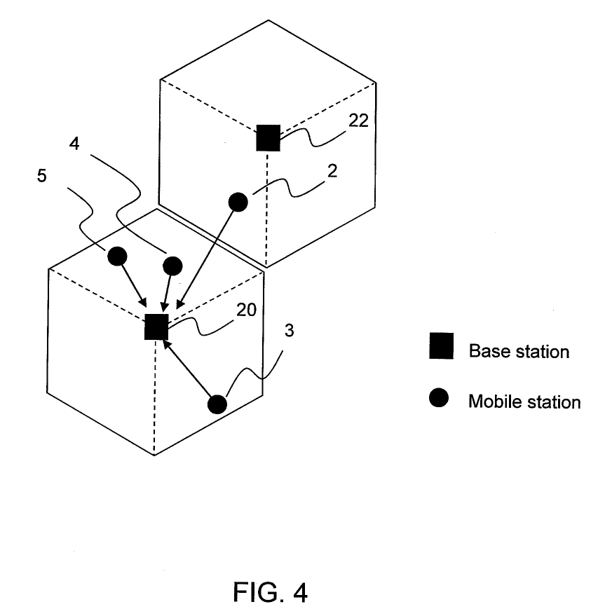

FIG. 5 is a diagram showing an example of beam forming;

FIG. 6 is a diagram showing an example of a power profile in a case where FFR is implemented according to an embodiment;

FIG. 7 is a diagram showing the directivities of beams in a case where beam forming and FFR are implemented;

FIG. 8 is a diagram for use in explaining the relationship between beam allocation in an ICIC zone and sub-channels;

FIG. 9 is a diagram for use in explaining a situation of a beam in an ICIC zone on a border of a cell in a case where plural base stations implement beam forming and FFR;

FIG. 10 is a diagram for use in explaining beam scheduling in an ICIC zone in a case where plural base stations implement beam forming and FFR;

FIG. 11 is a diagram for use in explaining beam allocation in the center of a cell and frequency allocation therein in a case where plural base stations implement beam forming and FFR;

FIG. 12 is a diagram for use in explaining beam scheduling in the center of a cell;

FIG. 13 is a diagram showing a sequence of CQI mode transition according to an embodiment of the present invention;

FIG. 14 is a diagram showing a sequence of CQI mode transition according to another embodiment of the present invention;

FIG. 15 is a diagram showing CQI mode transition according to the embodiment of the present invention;

FIG. 16 is a diagram showing CQI mode transition according to another embodiment of the present invention;

FIG. 17 is a diagram showing CQI mode transition according to still another embodiment of the present invention;

FIG. 18 is a diagram showing an operating flow of a base station according to the embodiment of the present invention;

FIG. 19 is a diagram showing an operating flow of the base station according to the embodiment of the present invention;

FIG. 20 is a diagram showing an operating flow of a terminal according to the embodiment of the present invention;

FIG. 21 is a diagram showing an operating flow of the terminal according to the embodiment of the present invention;

FIG. 22 is a diagram showing an inter-base station interface in the embodiment of the present invention;

FIG. 23 is a diagram showing the inter-base station interface in the embodiment of the present invention;

FIG. 24 is a block diagram showing a base station (baseband unit) in the embodiment of the present invention;

FIG. 25 is a block diagram showing a base station (wireless unit) in the embodiment of the present invention;

FIG. 26 is a diagram showing an example of a construction of a polarization-diversity array antenna;

FIG. 27 is a diagram showing a construction of a resource block in a case where the LTE protocol is adopted; and

FIG. 28 is an explanatory diagram showing an example of a sequence to be followed by a resource allocation scheduler in the embodiment of the present invention.

### DESCRIPTION OF THE PREFERRED EMBODIMENTS

### 1. Beam Forming

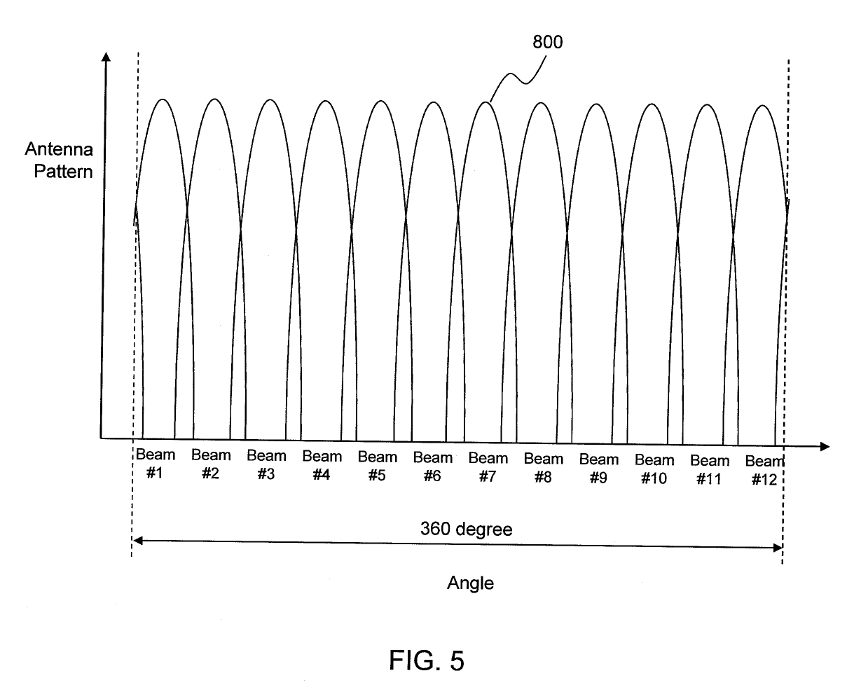

FIG. 5 is a diagram showing beam forming employed in an embodiment of the present invention. The axis of abscissas indicates angles and covers 360° over the entire length thereof from the left end thereof to the right end thereof. Twelve beams having a semi-fixed pattern are plotted. Curves 800 represent the beam pattern. The axis of ordinates signifies that an antenna gain for a beam gets higher in a direction from a lower part of the sheet of paper of the drawing to an upper part thereof. Each beam is formed according to, for example, a digital beam forming (DBF) technology. In the DBF, beam forming like the one shown in FIG. 5 is achieved by performing digital signal processing of applying an appropriate complex weight of a phase or amplitude to signals to be transmitted through plural antenna elements.

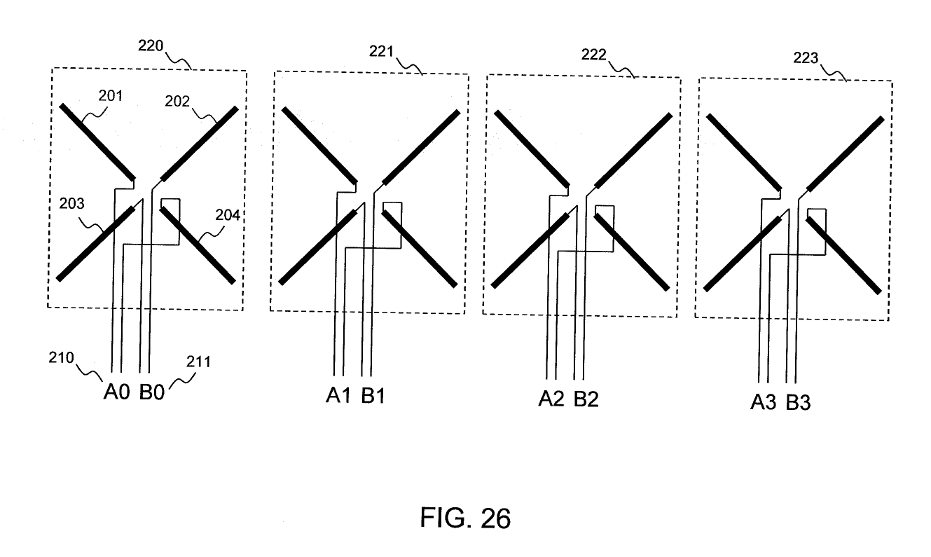

FIG. 26 is a diagram showing an example of a construction of a polarization-diversity array antenna.

FIG. 26 shows an example of an array of antenna elements that transmit or receive two orthogonal polarized waves. Herein, an element 201 and an element 204 are paired to form one dipole antenna. A plane of polarization lies in a direction at 45° counterclockwise from the vertical direction of the sheet of paper of the drawing. An antenna terminal through which the pair is excited is a port A0 (210). Likewise, an element 202 and an element 203 are paired to form a polarization dipole antenna tilted at 45° in a direction opposite to the port A0, that is, in a clockwise direction. A port through which the pair is excited is a port B0 211. A composite antenna element 220 including the antenna elements 201 to 204 and the two ports A0 and B0 is combined with composite antenna elements 221, 222, and 223 that have the same construction as the composite antenna element 220 and are juxtaposed, whereby the array antenna is constructed. Signals to which an appropriate array weight is applied are inputted to a group of antennas including the ports A (A0, A1, A2, and A3) of the constructed array antenna (220 to 223), whereby obliquely polarized beams are formed. Likewise, signals to which an appropriate array weight is applied are inputted to a group of antennas including ports B (B0, B1, B2, and B3) in order to form beams that are obliquely polarized in a direction opposite to the direction in which the obliquely polarized beams are formed through the ports A. Thus, two groups of beams of a group of beams A and a group of beams B that are different from each other in terms of a plane of polarization but are identical to each other in terms of beam directivity are produced.

The group of beams A produced through the ports A and the group of beams B produced through the ports B are two kinds of polarized beams that are orthogonal to each other. By transmitting different signals through the ports A and B, 2×2 multiple input/multiple output (MIMO) transmission is enabled. Specifically, in the present construction, a total of eight beams including four beams whose plane of polarization is 45° tilted counterclockwise and four beams whose plane of polarization is 45° tilted clockwise are formed. Two beams on different planes of polarization are paired, and four pairs of beams are formed. Each of the pairs of beams realizes a 2×2 MIMO structure.

When three antennas having the foregoing construction are disposed as if to form the sides of a regular triangle, if twelve beams shown in FIG. 5 are said to be formed, and each of the beams shall have the 2×2 MIMO structure.

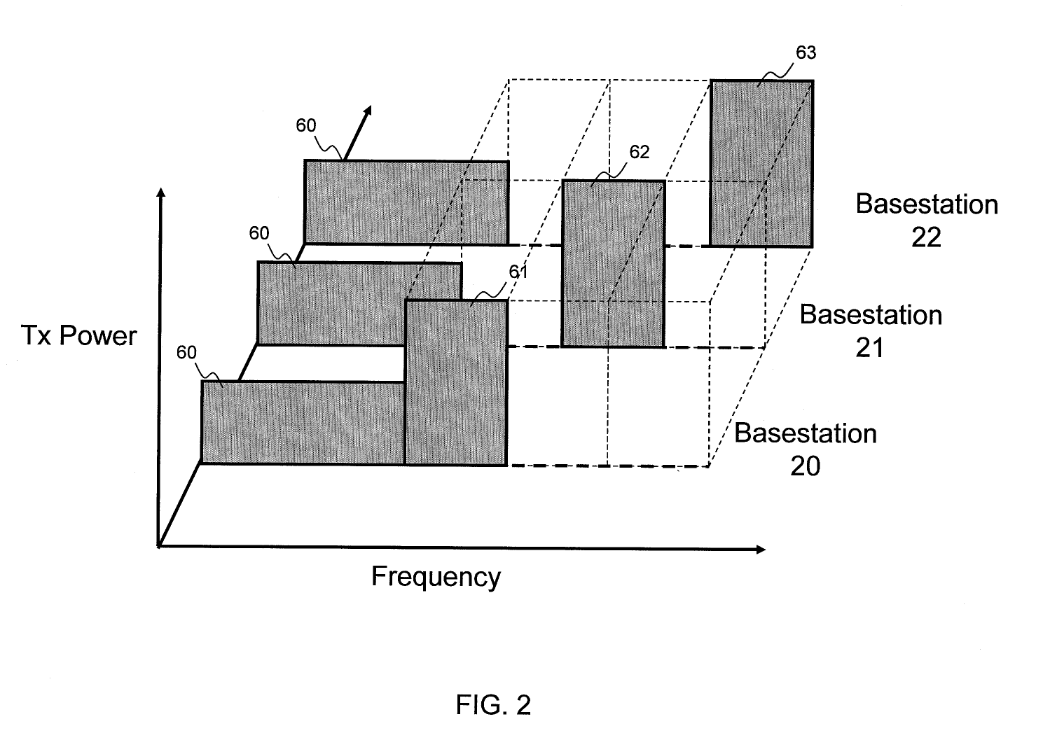

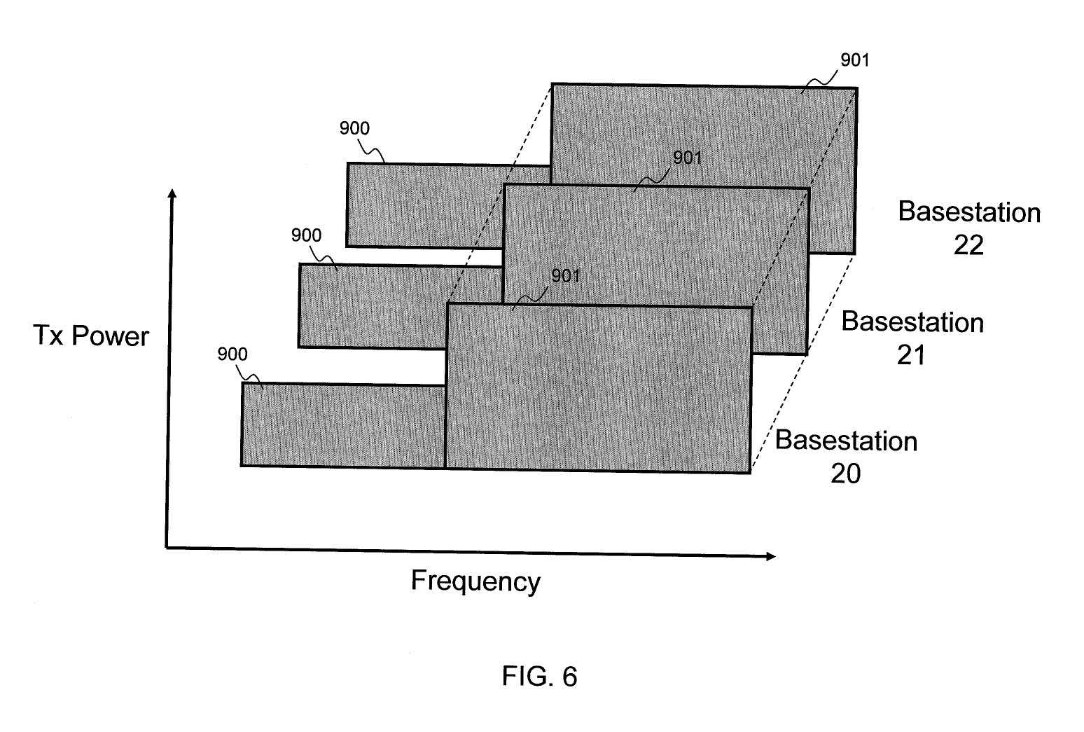

FIG. 6 shows a frequency range in a case where FFR is implemented according to the embodiment of the present invention. In the example shown in FIG. 2 and described as a related art previously, the base stations 20, 21, and 22 and the frequency bands 61, 62, and 63 are associated with one another on a one-to-one basis. Namely, the base station 20 uses the frequency bands 60 and 61 alone but does not allocate the frequency band 62 or 63.

However, in FIG. 6 for use in explaining the present embodiment of the present invention, another allocation method is adopted. For example, the base station 20 can transmit a signal at all frequencies in the frequency band 901. However, as a mechanism for reducing interference occurring between neighboring base stations, a beam that can be transmitted is determined based on a frequency. Interference avoidance is achieved using directivity. Therefore, in FIG. 6 showing a frequency domain and a sum of signal powers to be delivered with beams in respective sectors, a difference among the base stations 20, 21, and 22 is not observed.

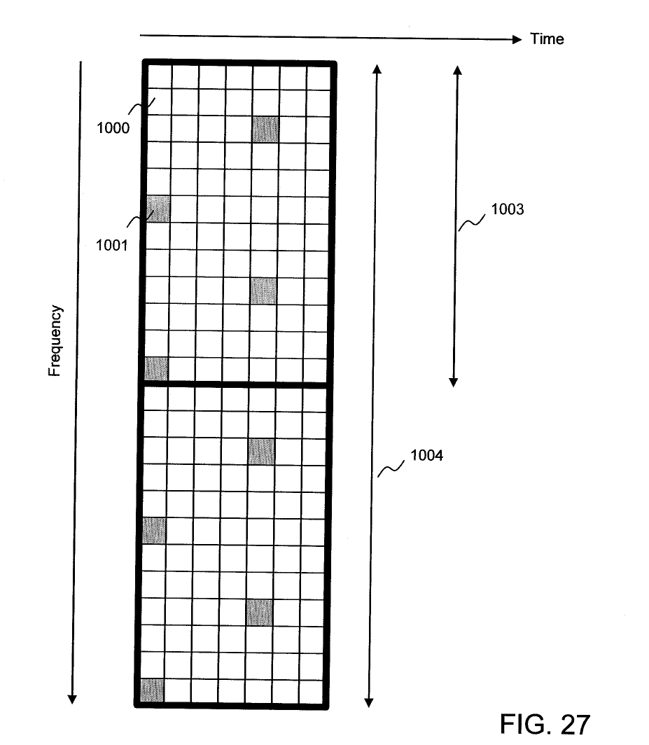

For describing the present invention and embodiment, concepts on a resource element, a resource block and a sub-channel have to be defined. Referring to FIG. 27, the resource element, resource block, and sub-channel will be described by taking for instance the long term evolution (LTE) protocol being discussed by the Third Generation Partnership Project (3GPP). In FIG. 27, frequencies are indicated in the vertical direction of the sheet of paper, and times are indicated in the lateral direction thereof. One square (1000) denotes a unit called a resource element. The length of the time axis for the resource elements is determined with an OFDM symbol length. The length of the frequency axis for the resource elements is determined with the number of data items to be subjected to fast Fourier transform (FFT) at the time of producing an OFDM symbol, and a system bandwidth. According to the LTE protocol, a product of twelve resource elements on the frequency axis by seven resource elements on the time axis constitutes a resource block (103).

In the present embodiment, two resource blocks constitute a sub-channel (1004). Resource elements (1001) expressed with hatched squares are included in each resource block. A reference signal is allocated to each of the resource elements. This structure is adopted in common for both an inter-cell interference coordination (ICIC) zone (zone associated with a border of a cell) and a non-ICIC zone (zone associated with the center of the cell). The sub-channel is not limited to two resource blocks but may include one resource block or three or more resource blocks.

A unit of packet allocation to be performed by a packet scheduler in a base station is the resource block irrespective of whether the resource block is included in the ICIC zone or non-ICIC zone. However, since a signal transmitted from a terminal belonging to the ICIC zone associated with a border of a cell interferes with a signal transmitted from another cell, transmission power for the signal is restricted through FTPC. Therefore, it is hard to ensure a throughput. The state of an uplink channel is reported in units of a sub-channel into which plural resource blocks are integrated. In the present embodiment, a description will be made based on an example in which two resource blocks are defined to constitute one sub-channel.

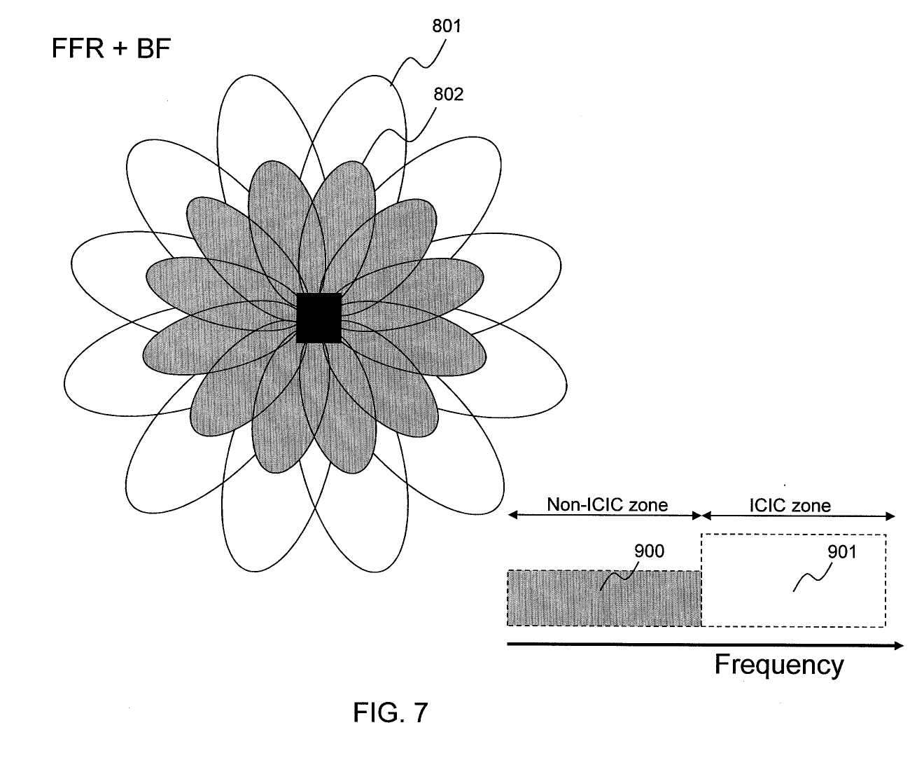

FIG. 7 shows a directivity pattern in a case where FFR and beam forming (BF) are combined according to the embodiment of the present invention. Beams 802 expressed with hatched inner ellipses are beams directed to terminals located in the center of a cell, and transmitted using a frequency band 900 of the non-ICIC zone with transmission power suppressed. Beams 801 expressed with non-hatched outer semi-ellipses are beams directed to terminals located on a border of a cell, and transmitted using a frequency band 901 of the ICIC zone by setting transmission power to a high level so that the beams can reach the border of the cell.

Hereinafter, the embodiment of the present invention will be described with respect to:
actions using the outer beams 801 in the ICIC zone 901
actions using the inner beams 802 in the non-ICIC zone 900
an action of switching the ICIC zone and non-ICIC zone
actions of software in a base station and that in a terminal
actions of hardware in the base station and that in the terminal
collaborative actions of base stations for the ICIC zone

In the present invention and present embodiment, frequencies are grouped into the ICIC zone and the non-ICIC zone. In the ICIC zone, beams are semi-fixedly allocated, and collaborative actions are performed by base stations. In the non-ICIC zone, beams are freely allocated in units of a cell. Beam allocation with high freedom is achieved to cope with positional deviation of terminals.

### 2. Actions in the ICIC Zone (Downlink)

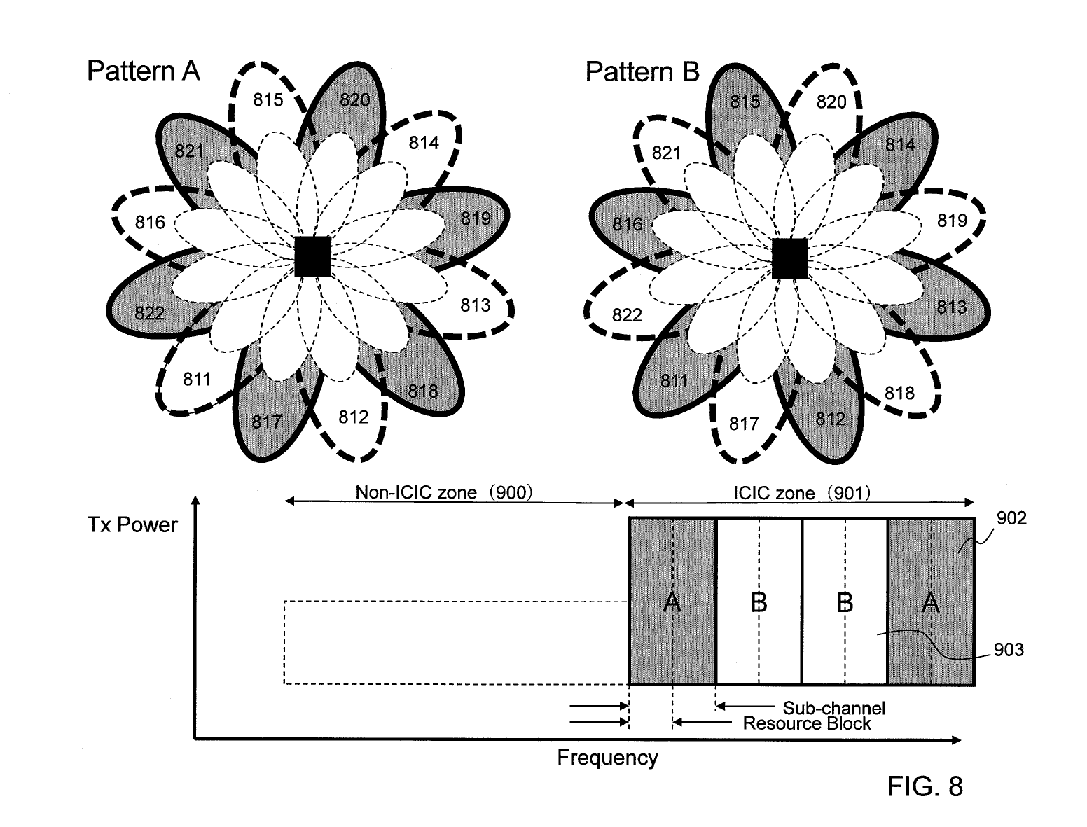

FIG. 8 shows allocation of beams to terminals located on a border of a cell. To the terminals located on the border of a cell, a frequency band 901 named an ICIC zone is allocated. When a certain frequency region within the frequency band 901 is noted, the frequency region is divided into finer frequency regions. The finer frequency regions shall be called sub-channels. The sub-channel includes one resource block or plural recourse blocks. In the drawing, an example in which two resource blocks constitute one sub-channel is shown.

In the embodiment of the present invention, the pattern of transmission beams varies depending on a sub-channel. The pattern falls into two kinds of patterns A and B. The patterns to be used for transmission are determined in advance in association with the sub-channels. For example, when a sub-channel 902 is employed, the beams are transmitted according to the pattern A. When a sub-channel 903 is employed, the beams are transmitted according to the pattern B. The allocation of the transmission-beam patterns is determined in a system, and the different patterns are adopted among base stations. In the transmission pattern A (pattern A in the drawing), beams 817, 818, 819, 820, 821, and 822 expressed with hatched semi-ellipses are transmitted. In the transmission pattern B (pattern B in the drawing), beams 811, 812, 813, 814, 815, and 816 expressed in hatched semi-ellipses on the right side of the drawing are transmitted. Beams expressed with semi-ellipses that are not hatched but are delineated with dashed lines are not used to transmit data signals each including a reference signal.

As mentioned above, since the beam pattern is varied depending on a sub-channel and a base station, an environment in which signal power of a desired wave and signal power of an interference wave vary depending on a sub-channel independently of each other is created for a terminal located at a certain position. A signal-to-interference and noise power ratio (SINR) greatly varies depending on the sub-channel. Allocation of the patterns A and B to the sub-channels is performed at random at each base station. Since the beam patterns are randomized, a condition for interference is determined in relation to each of states ranging from an excellent state to a terrible state. A situation of interference varies depending on the sub-channel. A terminal reports the situation of a propagation path in each sub-channel, and a scheduler in a base station recognizes a sub-channel in the excellent state, selects the sub-channel in the excellent state, and allocates the resource block of the sub-channel to the terminal. Thus, communication using the resource block offering the high SINR can be achieved.

In the embodiment of the present invention, beam scheduling in the ICIC zone is determined in advance with a sub-channel. A sub-channel to which no beam is allocated is not semi-permanently involved in the beam scheduling. For a beam that is not involved in the beam scheduling in the ICIC zone, transmission of a reference signal is suspended. Therefore, transmission of an unnecessary reference signal is prevented. This is effective in reducing interference.

In the drawing, when the pattern A and pattern B are scrutinized, transmission of signals using neighboring beams is avoided. For example, in the pattern A, a signal is transmitted using the beam 817, but no signal is transmitted using the neighboring beam 811 or 812. This is because interference between neighboring beams is intense. The inter-beam interference may be expressed as a dominant item, and the quality of a wireless path is degraded. As a result, a satisfactory throughput cannot be ensured.

According to an idea of ongoing beam randomization that is not combined with FFR, a terminal is requested to report an SINR over an entire frequency band supported by a system. This is because since the entire frequency band supported by a system is considered as resources to be allocated. Therefore, the terminal has to report the SINR concerning each of the resources arranged over the entire frequency band. However, in the embodiment of the present invention, a terminal located on a border of a cell may merely report information on a sub-channel within the ICIC-zone frequency band 901. On the border of a cell, an uplink throughput is limited because of implementation of FTPC. In the embodiment, necessary feedback information is only an SINR concerning a sub-channel in the ICIC zone. This is effective in reducing uplink overhead. For example, assume that the ratio of the non-ICIC zone to the ICIC zone is 1:1, and a sub-channel includes one resource block. In this case, according to the embodiment, compared with the related art, the terminal has to report only channel quality indicator (CQI) information (communication quality information) concerning a half of the resource block to a base station to which the terminal is connected. In the embodiment, plural resource blocks constitute one sub-channel, and beam allocation is performed in units of a sub-channel. Therefore, the number of sub-channels whose information has to be reported is smaller than the number of resource blocks constituting the ICIC zone. Owing to the devise, in the embodiment of the present invention, an amount of CQI information which the terminal located on the border of a cell has to report can be reduced. Eventually, the aforesaid problem can be solved.

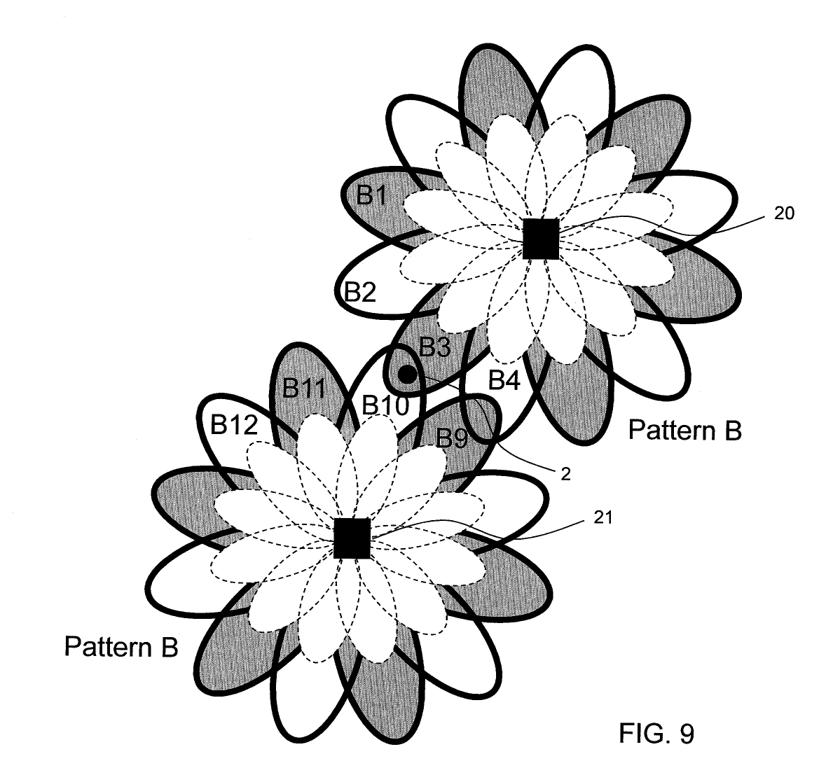

FIG. 9 is a diagram for use in explaining a relationship to a neighboring base station by extracting one sub-channel. A black square drawn in the center of a pattern expresses a base station, and a black circle expresses a terminal. Ellipses and semi-ellipses drawn around the black square expressing the base station conceptually express beams to be transmitted from the base station. Transmitted beams are expressed with hatched semi-ellipses. In the example of the sub-channel shown in FIG. 9, the base station 20 transmits signals according to the pattern B. The base station 21 also transmits signals according to the pattern B. To a terminal 2 connected to the base station 20, a beam 3 (B3 in the drawing) directed from the base station 20 to the terminal 2 itself is transmitted, that is, a desired wave is transmitted. A beam 10 (B10 in the drawing) that intensely interferes with the beam 3 is not transmitted from the base station 21 to the terminal 2. Interference is therefore not likely to occur. For the terminal 2, the sub-channel offers a high SINR.

Consideration will be taken into a case where different beam patterns are employed. For example, when a sub-channel in which the base station 20 transmits signals according to the pattern A is discussed, beams expressed with ellipses that are not hatched are transmitted from the base station 20. At this time, the beam 3 is not transmitted. Since the power of the desired wave is decreased, the SINR at the terminal 2 is low.

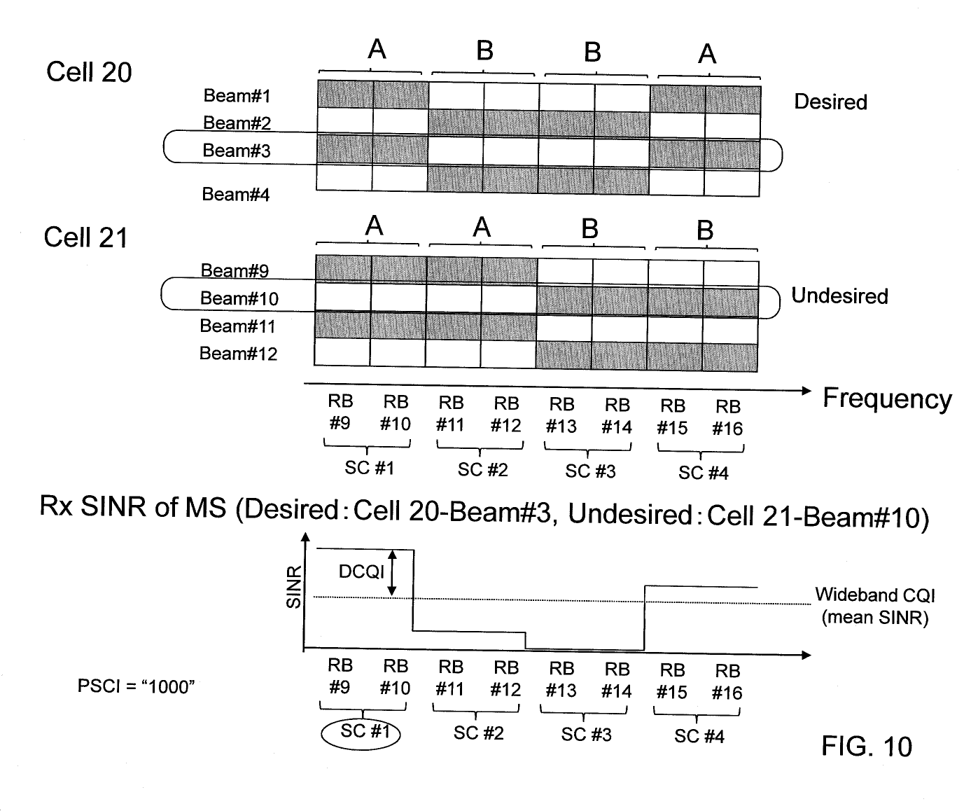

In FIG. 10, plural sub-channels are arranged for a better understanding of the fact that the SINR described in conjunction with FIG. 9 varies depending on a beam pattern. In the drawing, the axis of abscissas indicates frequencies. Eight resource blocks (that is, four sub-channels) are shown. The resource blocks RB are assigned serial numbers each preceded by # so that they can be discriminated from one another. In this example, two resource blocks constitute one sub-channel. The sub-channels SC are assigned serial numbers each preceded by # so that they can be discriminated from one another. The upper part of FIG. 10 shows beam allocation in two base stations (in cells 20 and 21). Although twelve beams are available as shown in FIG. 5, only four beams concerned are shown. In the drawing, a hatched rectangle signifies that a beam is transmitted in the associated sub-channel. A rectangle that is not hatched signifies that a beam is not transmitted in the associated sub-channel. A pattern of beams is determined in units of a sub-channel and is semi-fixed. “A” or “B” in the drawing signifies that the beam pattern A or B is used to transmit beams.

The base station 20 (cell 20) transmits signals by performing beam scheduling so that the beam patterns A, B, B, and A are used in that order in association with the sub-channels SC#1 to SC#4. The resource blocks RB#9 and RB#10 are paired to constitute the sub-channel SC#1. In the sub-channel SC#1, signals are transmitted using the beam pattern A. According to the beam pattern A, beams #1, #3, #5, etc. are transmitted. Likewise, the resource blocks RB#11 and RB#12 are paired to constitute the sub-channel SC#2. In the sub-channel SC#2, signals are transmitted using the beam pattern B. According to the beam pattern B, beams #2, #4, #6, etc. are transmitted. For the terminal 2, the beam 3 sent from the base station 20 is a beam directed to the terminal. Therefore, the sub-channels 1 and 4 indicated with SC#1 and SC#4 in the drawing are sub-channels offering high desired-wave power. The base station 21 (cell 21) that is a neighboring station transmits signals by performing beam scheduling so that the beam patterns A, A, B, and B are used in that order in association with the sub-channels SC#1 to SC#4. For the terminal 2, a beam #10 sent from the base station 21 is a beam directed to the terminal itself. When the neighboring station directs a beam to the terminal, interference power increases. Therefore, the sub-channels SC#3 and SC#4 are sub-channels causing high interference power. As a result, the sub-channel SC1 is regarded as the sub-channel offering a high SINR. The terminal 2 reports the results of measurement of the SINR to the base station. On response to the report, the base station implements scheduling. According to the present embodiment, the SINR in the ICIC zone alone should merely be reported, but the situation in the non-ICIC zone need not be reported. Therefore, overhead (amount of CQI information) necessary to reporting can be reduced. Eventually, the aforesaid problem can be solved.

Next, a way of reporting a channel state will be described below. For reporting, SINR values in all sub-channels may be quantized and then transmitted. Since beams are randomized, sub-channels offering satisfactory SINRs are limited. Therefore, even when information on all the sub-channels is reported, only resource blocks of the sub-channels offering the satisfactory SINRs are allocated in practice. Reporting SINR information on all the sub-channels is inefficient. In the embodiment of the present invention, three channel quality indicators (CQIs) of a wideband CQI or a wideband communication quality indicator, a difference communication quality indicator (DCQI), and an excellent communication indicator or a preferred sub-channel indicator (PSCI) are reported in order to reduce uplink overhead. The wideband CQI is used to report a mean SINR in the ICIC zone. The DCQI is used to report as a difference of an SINR of a certain subcarrier, which is excellent, from the mean SINR so as to signify how excellent the SINR of the subcarrier is. The preferred sub-channel indicator (PSCI) is used to report which sub-channel is proffered. The PSCI is bit-mapped information like the one shown in the left lower part of FIG. 10 and related to the sub-channels SC#1 to SC#4. In bit-mapped information, bits are associated with the sub-channels. The sub-channel associated with the bit of 1 offers an excellent characteristic.

In scheduling of beams expressed with hatched rectangles in FIG. 10, beam patterns to be used for transmission are determined. A data signal is not necessarily delivered by a determined beam. For example, if no terminal is covered by the beam, or although a terminal is covered by the beam, if there is no transmission information, data is not transmitted using the beam, but only a reference signal is transmitted. The reference signal is used to receive (detect) data, verify signal reception, or verify that the terminal is located in a zone covered by the beam. As described in conjunction with FIG. 27, the reference signal is assigned part of all resource elements. Therefore, when the reference signal alone is transmitted but a signal to which any other resource element is assigned is not transmitted, interference with a signal to be transmitted from any other base station is drastically reduced.

The terminal 2 uses the reference signal to estimate a SINR in an associated sub-channel. The SINR stands for a signal-to-interference and noise power ratio. A method of estimating the SINR using the reference signal will be briefed below.

A reference signal is, as shown in FIG. 27, assigned to any of resource elements defined like a mesh along a frequency axis and a time axis. As the reference signal, each base station transmits an inherent code sequence. A receiving signal is multiplied by a conjugate complex number of the sequence, whereby a propagation path traced by a resource element concerned can be estimated. The LTE protocol stipulates that the resource element to which the reference signal is assigned is offset on the frequency axis according to an ID of the base station. The position of a resource element assigned by a neighboring base station is different from that of the above resource element.

When a terminal receives a signal from a base station, a reference signal is extracted through de-mapping. In the de-mapping, the position on the frequency axis of the reference signal is identified based on the ID of the base station, and the reference signal is then extracted. The received reference signal is multiplied by a conjugate complex number of a code sequence to be transmitted in order to estimate a propagation path. A propagation path estimated using a reference signal adjacent in the time direction and frequency direction exhibit's a high correlation, and takes on an approximate value as a complex quantity. Using a statistical technique, the complex quantity representing the propagation path can be separated into a mean component and a dispersion component. The mean component is regarded as a signal component, and the dispersion component is regarded as an interference component. By obtaining the power ratio of the signal component to the interference component, an SINR can be calculated.

For estimating an SINR, there are various methods. The foregoing method is a mere example. Apparently, the present invention and present embodiment do not depend on the method. As another method, a terminal uses a reference signal sent from a desired base station, and measures the power of a signal component according to the foregoing method. In addition, neighbor list information that is information on ambient base stations notified by the base station is used to obtain information on a signal sequence transmitted from a neighboring base station. The information on the signal sequence is used to measure the power of the signal component transmitted from the neighboring base station and received by the terminal. A sum of signal components transmitted from neighboring base stations specified in the neighbor list and received by the terminal is calculated and regarded as interference power. An SINR is obtained based of the ratio of the above signal power to the interference power.

Even when either of the methods or any other method may be adopted, a terminal can obtain an SINR in relation to each resource block or each sub-channel. The terminal uses the SINR relevant to each sub-channel to calculate a wideband CQI that represents a mean SINR concerning the ICIC zone. A sub-channel offering the best SINR is selected, and a PSCI that is a bit map representing the sub-channel is produced. In addition, a DCQI that is a difference of the best SINR offered by the sub-channel from the wideband CQI representing the mean SINR is calculated.

### 3. Actions in the Non-ICIC Zone (Downlink)

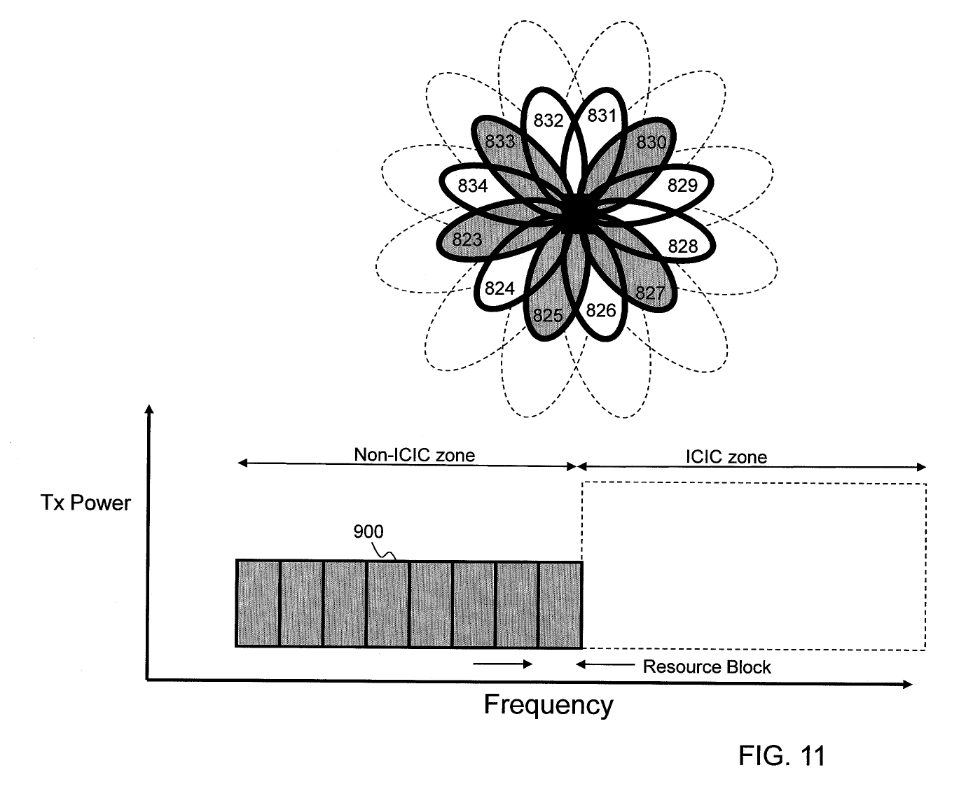

FIG. 11 shows allocation of beams directed to terminals located in the center of a cell. A frequency band 900 called a non-ICIC zone is allocated. When the non-ICIC zone is detailed, the non-ICIC zone can be divided into resource blocks that are frequency regions. The upper part of FIG. 11 shows an example of a situation of transmission of beams in a certain resource block. Herein, beams 823, 825, 8257, 830, and 833 expressed with hatched ellipses are transmitted. In other words, information is simultaneously transmitted to five terminals. At this time, beams 824, 826, 828, 829, 831, and 832 shown among the above beams do not deliver information in the same frequency region. Beam allocation is implemented for fear adjacent beams may be transmitted simultaneously. An effect of interference occurring in an own cell due to overlap of adjacent beams is thus reduced. In the center of the cell, since a difference in a distance between a desired station and a neighboring base station is large, a propagation loss of an interference wave can be made larger than that of a desired wave. Therefore, when interference with an adjacent beam in the own cell is compared with interference with a beam sent from a neighboring cell, the interference with the adjacent beam in the own cell is much intense. Therefore, a packet scheduler that allocates beams can freely schedule beams and packets in the own cell without the necessity of considering scheduling for a neighboring cell. This is in contrast to the operating method in the ICIC zone described in conjunction with FIG. 10. In the ICIC zone, beam scheduling is determined in advance in relation to each sub-channel, and is semi-fixed. Such restrictions are unnecessary in the non-ICIC zone. This adoption of these use methods is permitted by the present invention and present embodiment in which a frequency band is divided into the ICIC zone and non-ICIC zone, and FFR is used in combination.

In the case of the ICIC zone, scheduling of beams is determined in advance. Therefore, a sparse beam is used to transmit a reference signal alone but is not used to transmit data that may cause interference in order to cope with a traffic distribution or concentration of traffic on a specific direction. Thus, an attempt has been made to adjust inter-cell interference. However, in the non-ICIC zone, beam scheduling is not semi-fixed. Every time a scheduler allocates a sub-channel, the scheduler determines beams to be employed, and freely schedules the beams according to a request concerning traffic. For example, when traffic is concentrated on a specific direction, beams may be transmitted in the specific direction using a resource block of all the non-ICIC zone.

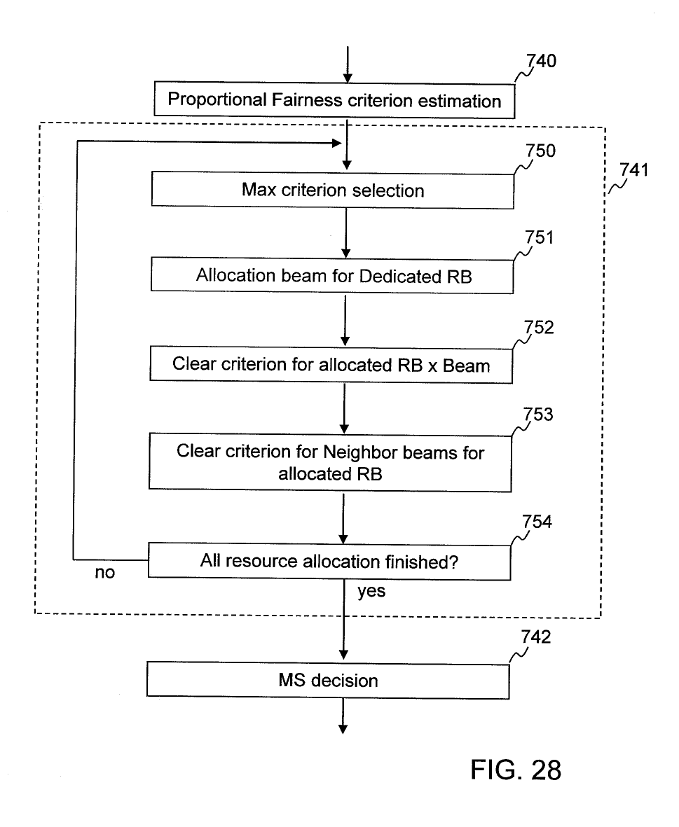

FIG. 28 shows an example of a flow of scheduling in the non-ICIC zone. An action of a packet scheduler in a base station is divided into three steps. The first step (740) is a step of calculating a proportional fairness evaluation function. Herein, a quotient of an SINR reported from a terminal by a mean throughput of the terminal is obtained as a criterion. The sum of criteria concerning terminals covered by a beam is obtained in relation to each resource block and each beam. The second step (741) is a step of determining beams to be transmitted. The contents of the second step will be detailed later. The third step is a step of determining a mobile station (MS) to which a packet is transmitted.

At the second step, a resource block and a beam providing the highest one of criteria collected in relation to resource blocks and beams are selected (750), and transmission of the beam in the resource block is determined (751). Thereafter, the criterion for the beam in the resource block is cleared (752). In addition, criteria for two beams adjacent to the beam in the resource block are cleared for fear the beams may be allocated (753). The series of actions is continued until all criteria are cleared, whereby whether all resources have been allocated is decided (754). The beam allocation algorithm is implemented at intervals of a period at intervals of which a packet scheduler is activated (at intervals of a sub-frame in the present embodiment).

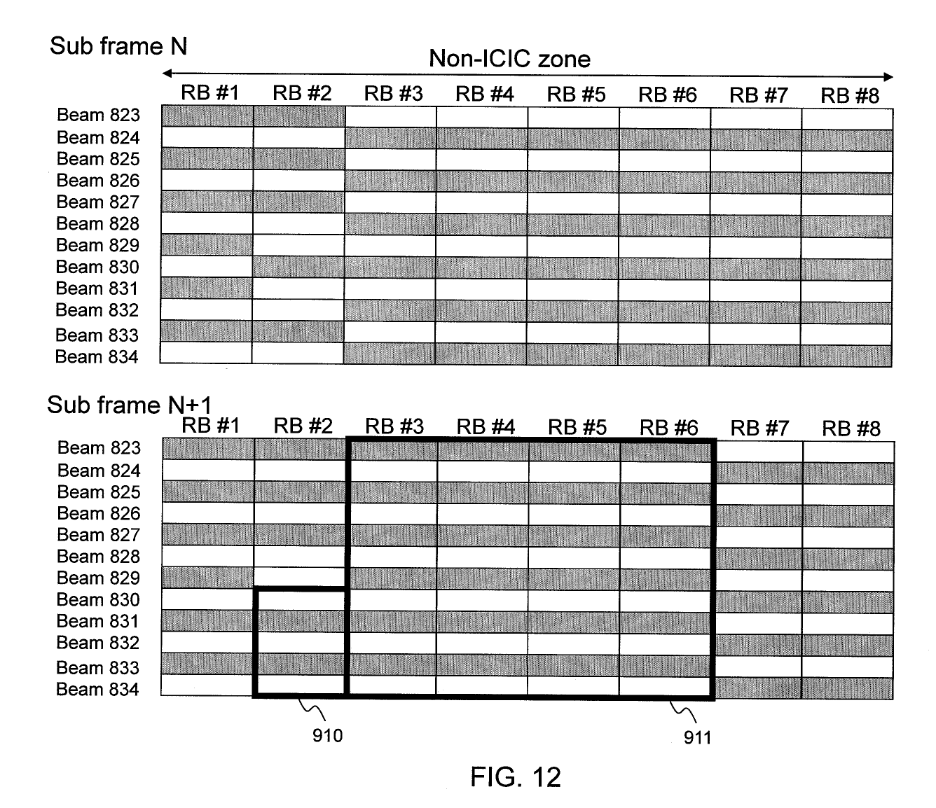

FIG. 12 shows an example of beam scheduling in the non-ICIC zone. The upper part of the drawing shows information on scheduling for a sub-frame N, and the lower part thereof shows information on scheduling for a sub-frame N+1. Namely, a situation of allocation in beam scheduling performed during successive sub-frames is described in the upper and lower parts of the drawing.

In the upper and lower parts of the drawing, each of hatched rectangles signifies that a beams indicates on the left side is transmitted in a resource block indicated on the upper side. Scheduling is performed in relation to each resource block at intervals of a sub-frame. The resource block (RB) is the minimum unit in which a channel is allocated, and includes plural subcarrier bands. During the sub-frame N (upper part), beams 823, 825, 827, 829, 831, and 833 are transmitted in a resource block RB#1. Beams 823, 825, 827, 830, and 833 are transmitted in a resource block RB#2. Beams 824, 826, 828, 830, 832, and 834 are transmitted in resource blocks RB#3 to #8.

A point to be described in conjunction with the drawing is that beam scheduling is changed from the upper part of the drawing to the lower part thereof. Between the sub-frame N (upper part) and succeeding sub-frame N+1 (lower part), beam scheduling is changed within a range from the resource block RB#2 to resource block RB#6 delineated with a bold line in the drawing. In the non-ICIC zone, a fixed beam pattern is not used, but beams are scheduled at intervals of a sub-frame corresponding to a period at interval of which packets are allocated. Thus, the beams can be allocated according to traffic. In the ICIC zone, a beam pattern for a sub-channel (one resource block or plural resource blocks) is determined based on a pre-determined beam schedule. Therefore, allocating beams according to traffic cannot be performed. However, in the non-ICIC zone, as shown in the drawing, beam scheduling is freely modified at intervals of a frame. Therefore, degradation in efficiency caused by restrictions arisen by adopting a pre-determined beam pattern can be suppressed. Eventually, the aforesaid problem can be solved.

Next, a way of reporting a channel state will be described below. In the non-ICIC zone, an SINR to be observed when a beam is directed to a terminal is estimated in relation to each resource block, and a wideband channel quality indicator (CQI) that represents a mean value of SINRs is calculated. In addition, a preferred beam indicator (PBI) or an excellent beam indicator representing an excellent beam number is transmitted. Thus, it is the constituent feature of the present invention and present embodiment that a terminal using the ICIC zone and a terminal using the non-ICIC zone are different from each other in information to be sent as a CQI. Since a situation of interference is also different between the terminals, a base station instructs each of the terminals to report channel information (CQI) dependent on the situation. A method of instruction will be described later.

### 4. Action of Switching the ICIC Zone and Non-ICIC Zone

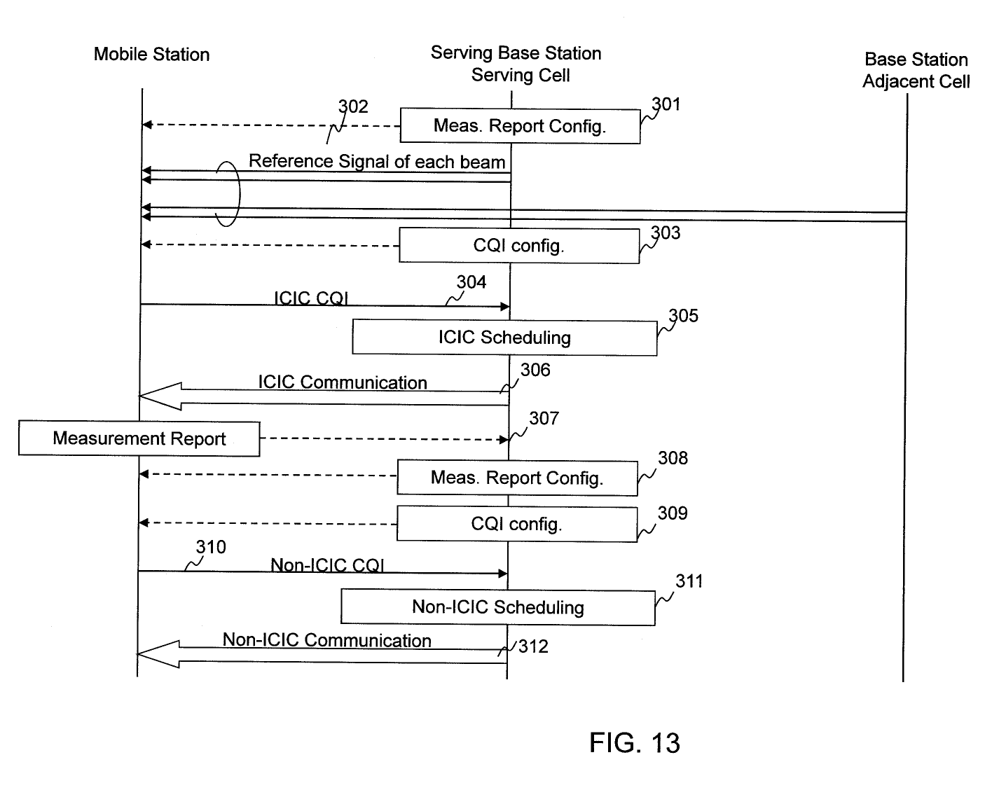

FIG. 13 shows a control sequence in the embodiment of the present invention. Passage of time is indicated in the lengthwise direction in the drawing, and time passes in a direction from the upper part of the drawing to the lower part thereof. In the drawing, a terminal (mobile station), a base station (serving cell), and a neighboring base station (adjacent cell) are shown as nodes.

The base station performs two settings on the terminal. One of the settings is to set a trap in order to decide whether the ICIC zone and non-ICIC zone are switched. The other one is to set a CQI to be reported by the terminal.

A description will be made of the first setting for deciding whether the ICIC zone and non-ICIC zone are switched. The base station sets a trap on the terminal, which is connected to the base station, so as to assign the terminal to the ICIC zone. Setting a trap is performed using a measurement report configuration. For the trap, a mean receiving signal intensity PS of a reference signal, which is transmitted from the base station to which the terminal is connected, over an entire system bandwidth is compared with a mean receiving intensity PA at a neighboring base station that takes on the largest value among mean receiving intensities of reference signals transmitted from the neighboring base station over an entire system bandwidth. When the difference becomes equal to or larger than a threshold T1, that is, when PS−PS>T1 is satisfied, a trap is activated. When the trap is activated, the terminal reports occurrence of the event to the base station. For reporting, a measurement report is employed. In response to the report, the base station determines a transition from the ICIC zone to the non-ICIC zone. In contrast, another trap is set on a terminal for which a transition has been made to the non-ICIC zone so that the ICIC zone can be restored. For example, for the trap to be set in order to restore the ICIC zone, when a threshold T2 is used and PS−PA<T2 is satisfied, the terminal sends a report to the base station.

The second setting of a CQI to be reported by a terminal will be described below. As described previously, information to be reported with the CQI is different between when the terminal lies in a place associated with the ICIC zone and when the terminal lies in a place associated with the non-ICIC zone. Namely, a wideband CQI, a PSCI, and a DCQI are reported using the ICIC zone, while the wideband CQI and a PBI are reported using the non-ICIC zone. The items to be reported and the intervals at which the items are reported have to be set. The terminal reports the CQI in response to a designation sent from the base station.

Referring back to FIG. 13, a description will proceed. The terminal has the reporting contents of a result of measurement, a format, and a trigger, and the like, set therein in line with the measurement report configuration sent from the serving cell (301). The instruction includes information concerning a threshold for the receiving quality of a reference signal sent from each cell which is measured by the terminal. When the receiving quality of a reference signal to be received from each sector or cell falls below or exceeds a set threshold, the terminal is triggered and reports the fact to the base station. The base station instructs the terminal to change modes according to the report.

In the embodiment of the present invention described in FIG. 13, plural beams are used to perform communications in each sector. A discrete reference signal is transmitted from each sector using one of the plural beams (302). The terminal receives the reference signal, and decides whether the condition of the threshold specified in the measurement report configuration is met. For communication, the base station instructs the terminal (303) to enter a certain CQI mode (ICIC). In the embodiment of the present invention, a CQI to be reported varies depending on the mode. Therefore, in the embodiment of the present invention, a CQI report mode is changed based on a CQI configuration sent from the base station. Herein, assume that a CQI associated with the ICIC zone is instructed to be reported. In response to the instruction, the terminal reports the CQI associated with the ICIC zone (304). The base station uses the result to perform scheduling of the ICIC zone (305). Based on the results of the scheduling, communication is performed using the ICIC zone (306).

Assuming that a receiving situation of a reference signal satisfies the conditions set at step 301, the terminal posts a measurement report to the base station (307). Herein, assume that the difference between a receiving level PA of a reference signal sent from a neighboring base station and a receiving level PS of a reference signal sent from a base station to which the terminal is connected is equal to or larger than the threshold T1, that is, PS−PA>T1 is satisfied. On receipt of the measurement report, the base station recognizes that the terminal has approached the center of a cell, and determines a transition from the ICIC zone to the non-ICIC zone. To begin with, the measurement report configuration is reset (308). Owing to the resetting, a trigger is set so that when the terminal reenters the place associated with the ICIC zone, the terminal will post a report to the base station. A CQI configuration is transmitted so that the CQI mode can be changed to a mode associated with the non-ICIC zone (309). Accordingly, a CQI report to be sent from the terminal is changed to the one associated with the non-ICIC zone (310). A packet scheduler in the base station uses the result to perform scheduling in the non-ICIC mode (311). Communication using the non-ICIC zone is then carried out (312).

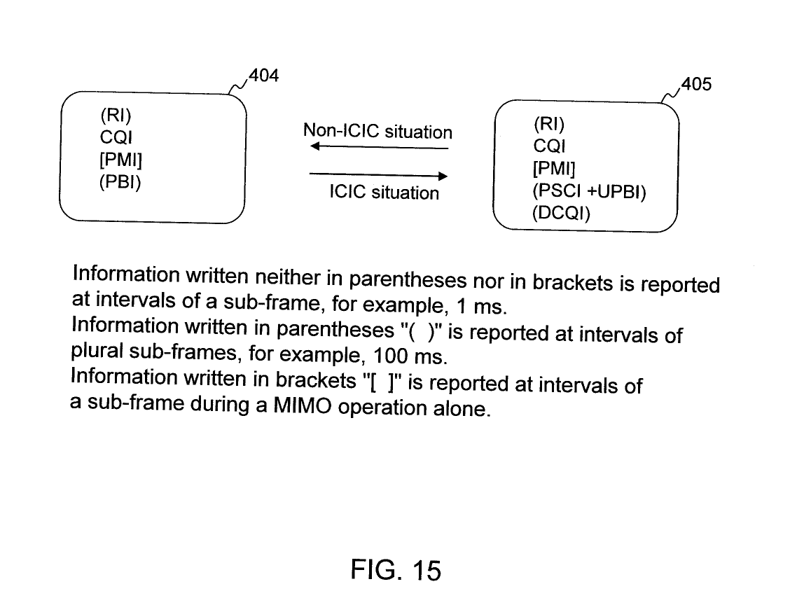

FIG. 15 is a diagram showing a CQI mode transition between the non-ICIC mode (404) and ICIC mode (405). When a terminal in the ICIC mode (405) meets the condition for entering the non-ICIC mode, the terminal reports the fact to a base station, makes a mode transition in response to an instruction sent from the base station, and enters the non-ICIC mode (404). In contrast, a terminal in the non-ICIC mode (404) meets the condition for entering the ICIC mode, the terminal reports the fact to the base station, makes a mode transition in response to an instruction sent from the base station, and enters the ICIC mode (405). In FIG. 15, parentheses and brackets are employed. Why they are employed will be described below. Information written neither in parentheses nor in brackets is information to be reported at intervals of a sub-frame. For example, when a sub-frame length is 1 ms, the information is reported at intervals of 1 ms. Information written in parentheses is reported at intervals of plural sub-frames, for example, reported at intervals of 100 ms. Information written in brackets is information to be reported at intervals of a sub-frame only during an MIMO operation. In the ICIC mode, in addition to the aforesaid CQI, PSCI, and DCQI, an un-preferred beam indicator (UPBI) or a defective beam indicator to be used for inter-base station collaboration, a rank indicator (RI) to be used to report ranks of polarized antennas employed in the MIMO operation, and a PMI to be used to designate a pre-coding matrix for the polarized antennas are transmitted. The UPBI will be detailed at the time of describing collaborative actions of base stations.

In the non-ICIC mode, the RI, CQI, PMI, and PBI are reported. A difference from the ICIC mode is that the PBI is reported in place of the DCQI and PSCI.

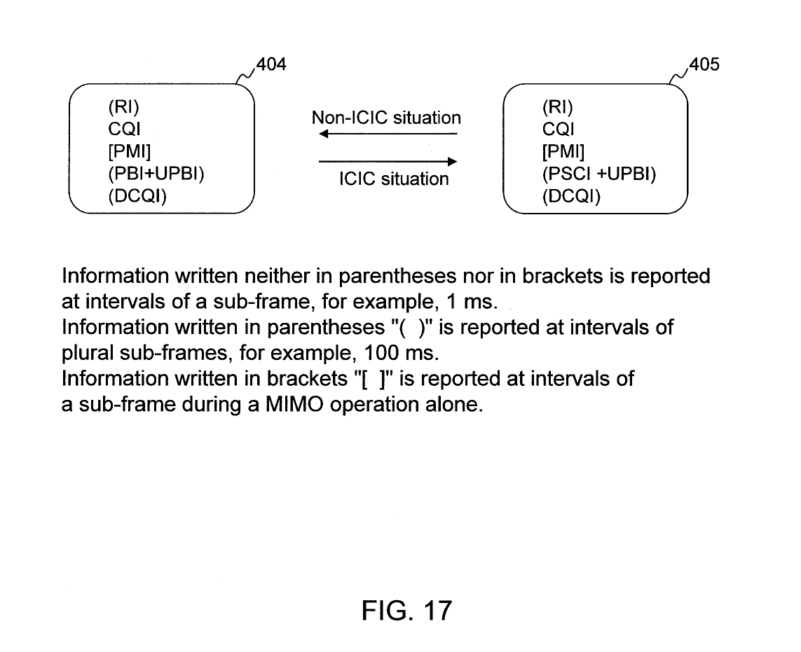

FIG. 17 is a transition diagram of CQI modes in another embodiment. In FIG. 15, the non-ICIC mode (404) is shown as a mode in which the UPBI is not transmitted. As shown in FIG. 17, a mode in which the PBI and UPBI are transmitted may be defined as the non-ICIC mode. When beams well-shaped as shown in FIG. 5 are produced, the necessity of defining beams that interfere with each other is little. When the well-shaped beams cannot be produced because the space between antenna elements is widened, even if the non-ICIC zone is used, information specifying the beams that interfere with each other is given to a base station. Thus, beam scheduling or packet scheduling can be performed so that inter-beam interference will hardly occur.

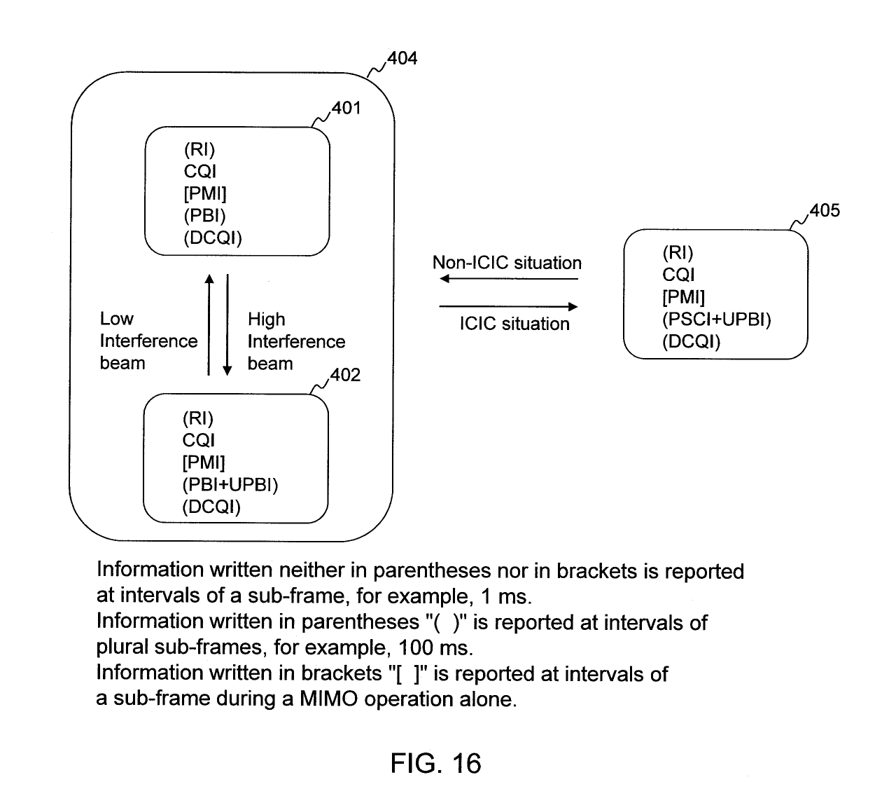

FIG. 16 is a transition diagram of CQI modes in another embodiment. Unlike FIG. 15, FIG. 16 shows two modes included in the non-ICIC mode (404). The first mode is a low interference (LI) mode that is a mode to be adopted when interference with another beam is limited. The another beam may be a beam within the same cell or a beam in another cell. The other mode is a high interference (HI) mode that is a mode to be adopted when interference with another beam is intense. In the LI mode, PBI information alone is transmitted. In the HI mode, UPBI information specifying a beam that intensely interferes with another is reported in addition to the PBI. When an interfering party lies in the own cell, a base station uses the pieces of information to schedule beams for fear either a beam specified in the PBI or a beam specified in the UPBI may be allocated to the same resource block. When the interfering party lies in another cell, scheduling is performed so that a signal can be transmitted to the terminal in a resource block in relation to which the use rate of a beam is specified as “low (L)” in a beam transmission indicator (BTI) or a transmission rate indication that is an inter-base station interface.

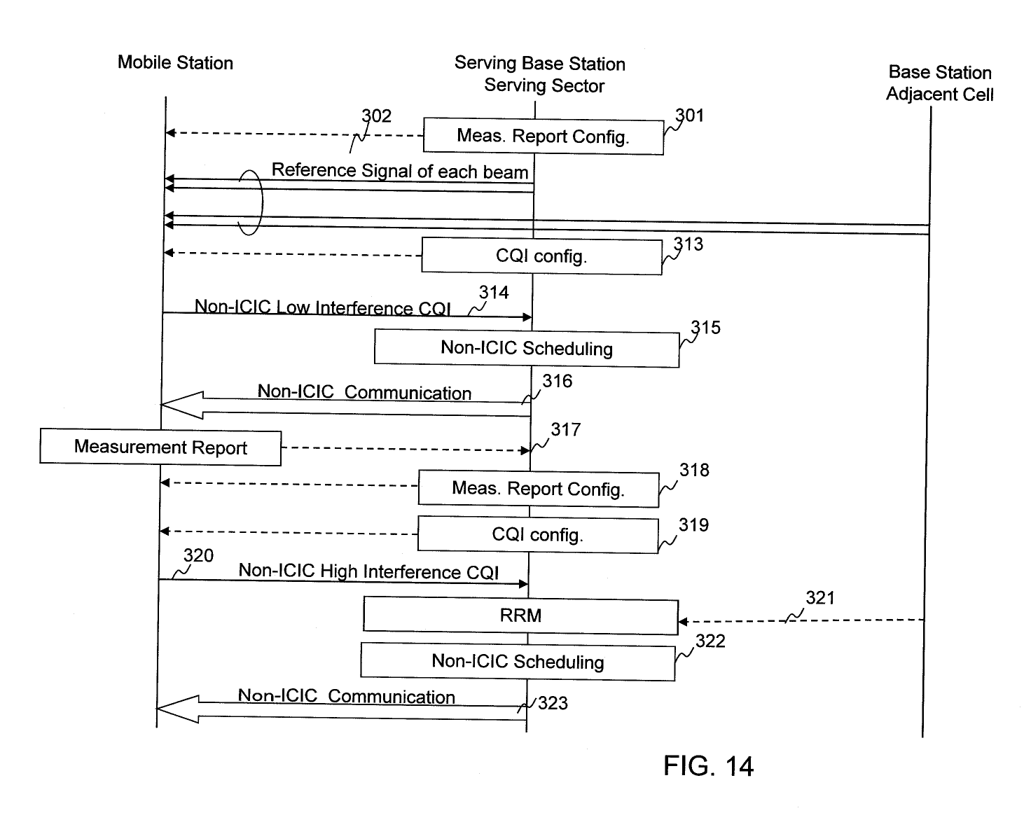

A CQI mode transition in the non-ICIC mode shown in FIG. 16 will be described in conjunction with FIG. 14. A terminal has the reporting contents of a result of measurement, a format, and a trigger set therein according to a measurement report configuration sent from a serving cell (301). Plural beams can be transmitted in each of sectors supported by a base station, and a discrete reference signal is transmitted using each of the beams (302). The terminal receives the reference signal, and decides whether the condition of the threshold specified in the measurement report configuration is met. For communication, the base station instructs the terminal to enter a certain CQI mode (313). In the embodiment of the present invention, a CQI to be reported varies depending on a mode. Therefore, in the embodiment of the present invention, a CQI report mode is changed according to a CQI configuration sent from the base station. Herein, the CQI defined in the non-ICIC LI mode shall be instructed to be reported. In response to the instruction, the terminal reports the CQI defined in the non-ICIC LI mode (314). The base station uses the result to perform scheduling of the non-ICIC zone (315). Based on the results of the scheduling, communication using the non-ICIC zone is carried out (316).

Assuming that a receiving situation of a reference signal meets the conditions set at step 301, a relevant measurement report is transmitted from the terminal to the base station (317). Assume that a difference between a receiving level PAB of a reference signal delivered with a specific beam and a receiving level PSB of a reference signal delivered with a beam directed to the terminal connected to the base station falls within a threshold T3, that is, PSB−PAB<T3 is satisfied. When this trigger event takes place, a measurement report configuration is reset if necessary so that the HI mode can be restored (318). In addition, a CQI configuration is transmitted so that the CQI mode can be changed to the non-ICIC HI mode (319). Accordingly, a CQI report to be sent from the terminal is changed to the CQI defined for the HI mode (320). From a neighboring base station, a BTI that is beam scheduling information concerning the neighboring base station is posted (321). Information on a beam, which causes intense interference and is sent from the terminal, and information on beam scheduling in the neighboring station are used to perform packet scheduling, in which to what terminal a packet is transmitted using a specific beam is determined, after beam scheduling is completed at steps 741 and 742 in FIG. 28 (322). Then, communication using the non-ICIC-zone frequency band is carried out (323).

### 5. Actions of Software in a Base Station and Software in a Terminal

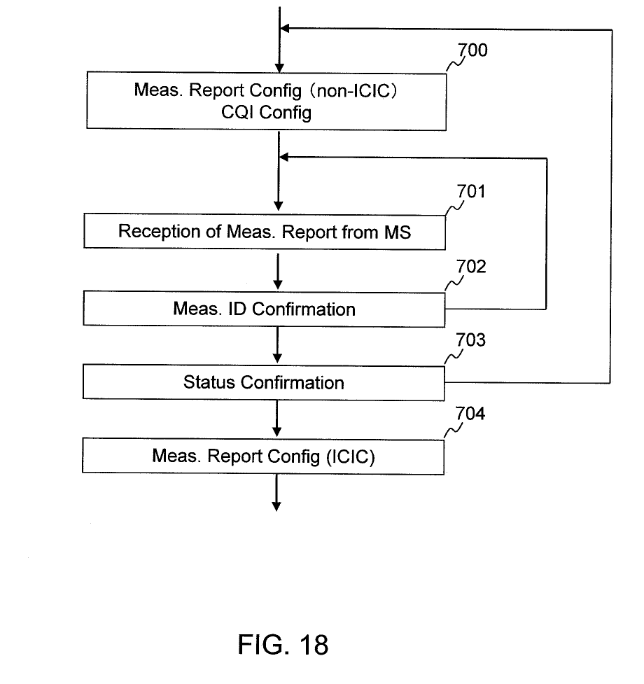

FIG. 18 shows an operating flow to be followed by a base station in order to decide whether a terminal operating in the non-ICIC mode is allowed to make a transition to the ICIC mode, and to, if necessary, switch the non-ICIC mode to the ICIC mode.

To begin with, a base station sets a measurement report configuration, which specifies a condition for a transition from the non-ICIC mode to the ICIC mode, in a terminal concerned at step 700. Since plural measurement report configurations can be set in the terminal, the base station also transmits a measurement ID that is an identifier with which the set measurement report configuration can be identified. The base station can instruct the terminal to enter the non-ICIC mode. At the next step 701, the base station waits for a measurement report sent from the terminal. When the base station receives the measurement report from the terminal, the base station proceeds to the next step 702. At step 702, the base station checks a measurement ID appended to the measurement report. If the measurement ID does not signify a transition from the non-ICIC mode to the ICIC mode expected by the software, the base station returns to step 701, and waits for the next measurement report. If the measurement IDs square with each other, the base station proceeds to the next step 703. At the step 703, the base station checks a status. The base station decides whether the status of the terminal which the base station is notified by the measurement report is consistent with the condition for a transition to the ICIC mode. If the status is consistent with the condition for a transition, the base station proceeds to the next step 704. If the status is not consistent with the condition for the transition, the base station returns to step 700 so as to reset a CQI configuration. At the step 704, the base station instructs the terminal to make a transition to the ICIC mode. Specifically, the base station sets the measurement report configuration as a trigger for the transition so that the terminal can be restored to the non-ICIC mode, and transmits a CQI configuration command to the terminal so as to instruct the terminal to change the CQI mode to the ICIC CQI mode.

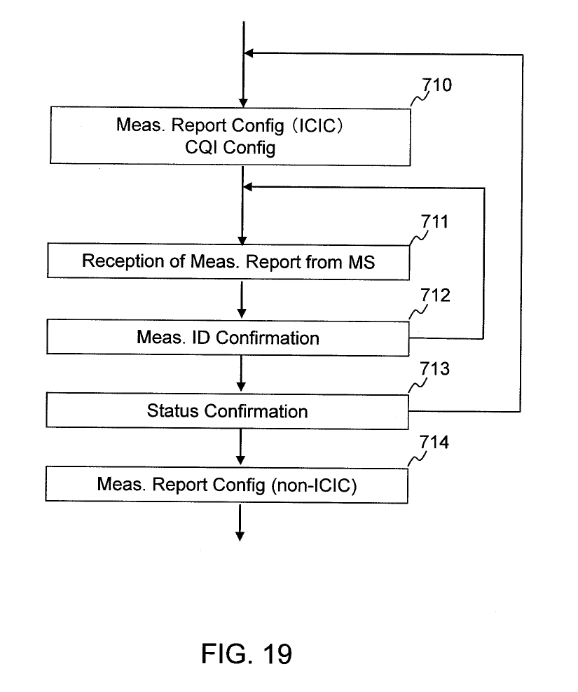

FIG. 19 shows an operating flow to be followed by a base station in order to set, in contrast with FIG. 18, a terminal, which operates in the ICIC mode, to the non-ICIC mode.

To begin with, the base station sets at step 710 a measurement report configuration, which specifies a condition for a transition from the ICIC mode to the non-ICIC mode, in a terminal concerned. Since plural measurement configurations can be set in the terminal, the base station also transmits a measurement ID that is an identifier with which the set measurement report configuration can be identified. In addition, the base station can instruct the terminal to enter the ICIC mode. At the next step 711, the base station waits for a measurement report posted from the terminal. When the base station receives the measurement report from the terminal, the base station proceeds to the next step 712. At the step 712, the base station checks a measurement ID appended to the measurement report. If the measurement ID does not signify a transition from the ICIC mode to the non-ICIC mode expected by the software, the base station returns to step 711, and waits for the next measurement report. If the measurement IDs square with each other, the base station proceeds to the next step 713. At the step 713, the base station checks a status. If the status of the terminal which the base station is notified by the measurement report is consistent with the condition for a transition to the non-ICIC mode, the base station proceeds to the next step 714. If the status of the terminal is inconsistent with the condition, the base station returns to step 710 so as to reset a CQI configuration. At the step 714, the base station instructs the terminal to make a transition to the non-ICIC mode. Specifically, the base station sets a measurement report configuration as a trigger for the transition so that the terminal can be restored to the ICIC mode, and transmits a CQI configuration command to the terminal so as to instruct the terminal to change the CQI mode to the non-ICIC CQI mode.

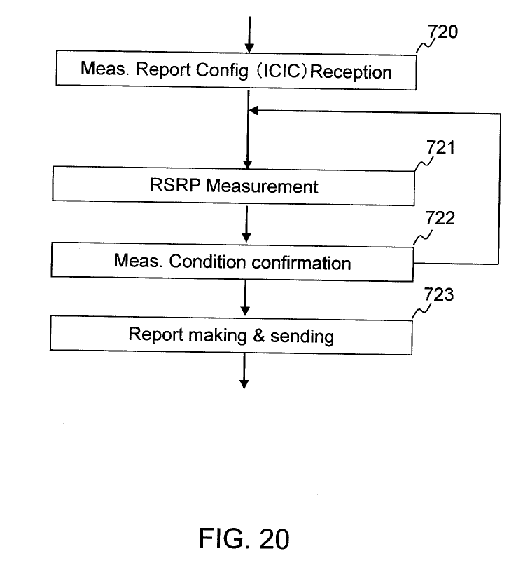

FIG. 20 shows an operating flow to be followed by a terminal in the ICIC mode. First, at step 720, the terminal receives a measurement report configuration from a base station, and receives an instruction saying that the terminal should post a CQI report defined for the ICIC mode. The terminal proceeds to the next step 721, and measures a reference signal. For the measurement, the terminal receives a reference signal sent from the base station to which the terminal is connected, and a reference signal sent from a neighboring station, and measures receiving powers of the reference signals or reference signal received powers (RSRPs). When the measurement is completed, the terminal proceeds to step 722. At step 722, the terminal decides whether the result of the measurement satisfies a condition set by the base station at step 720. If the result of the measurement does not satisfy the condition, the terminal returns to step 721, and performs the next measurement. The measurement is regularly carried out, and the result of the measurement is checked every time to see if it satisfies the condition. If the result of the measurement satisfies the condition, the terminal proceeds to step 723. At step 723, the terminal produces a report to be posted to the base station, and transmits the report to the base station.

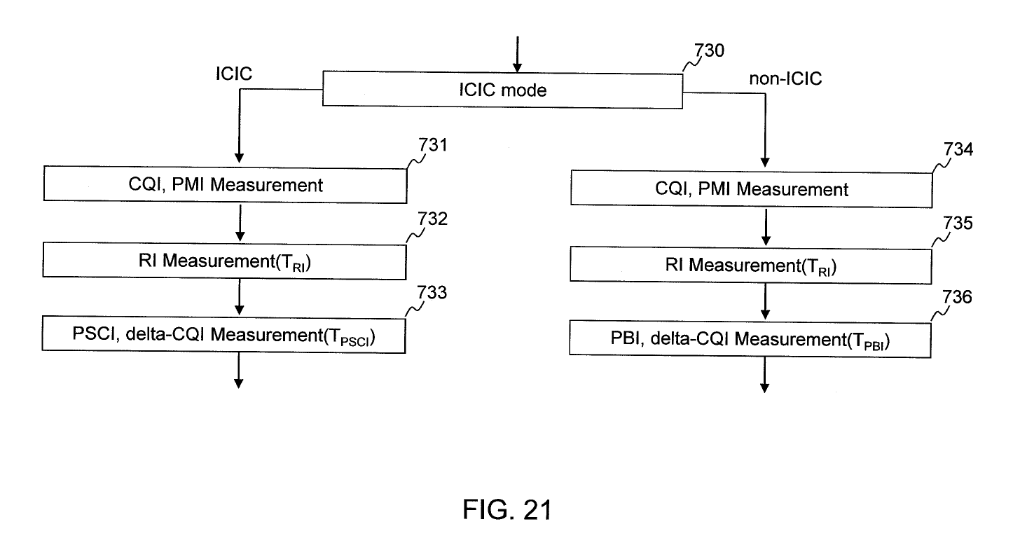

FIG. 21 is a flowchart showing a mechanism according to which a CQI to be reported by a terminal varies depending on a mode. The terminal makes a choice according to the ICIC mode or non-ICIC mode specified in a CQI configuration by a base station. When selecting the ICIC mode shown on the left side of the drawing, the terminal measures pieces of information such as a CQI and a PMI (731), an IR (732), and a PSCI and a DCQI (733), and reports the results of the measurement to the base station. When selecting the non-ICIC mode, the terminal measures the CQI and PMI (734), the RI (735), and the PBI, and reports the results of the measurement to the base station.

### 6. Actions of Hardware at a Base Station and Hardware at a Terminal

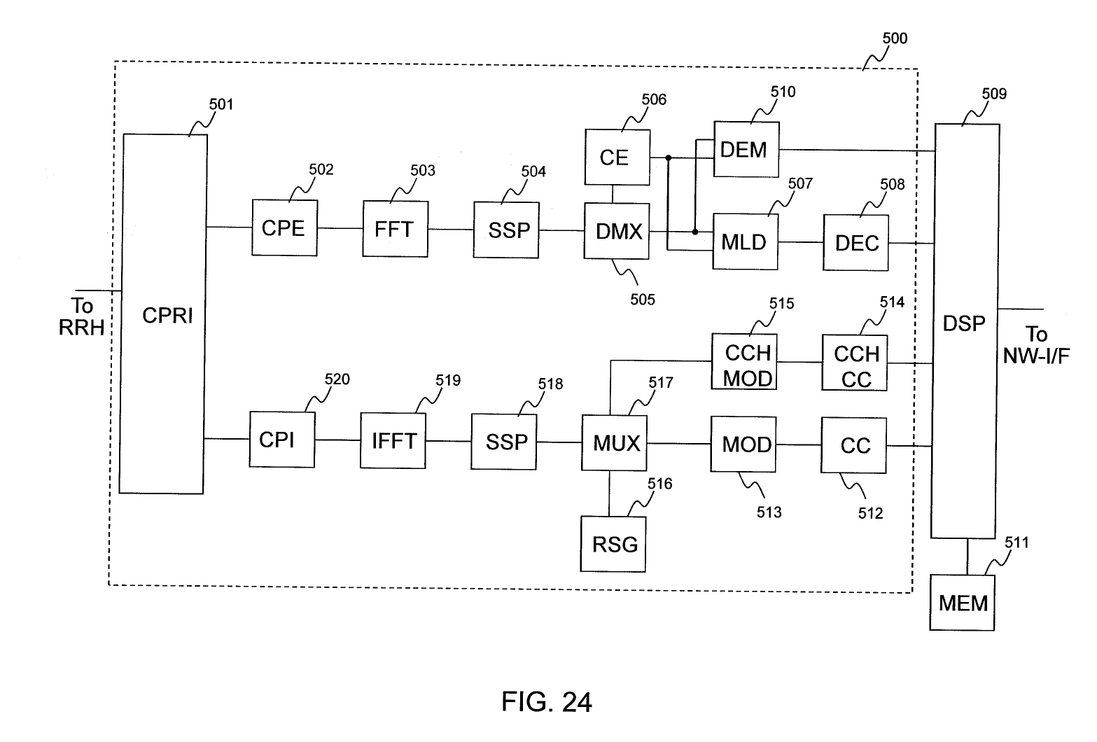

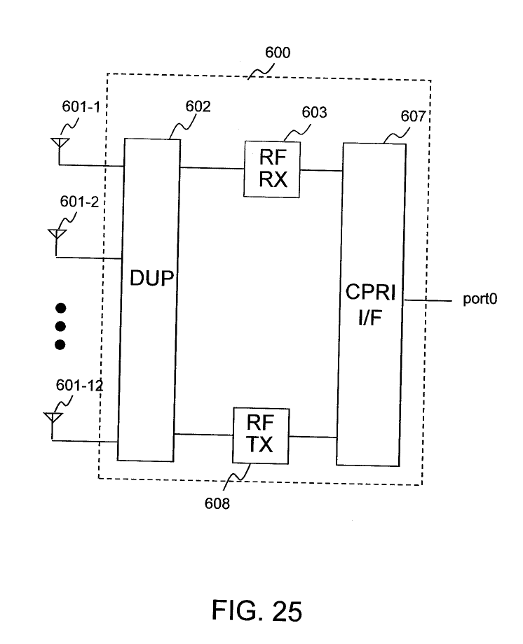

FIG. 24 is a diagram showing an example of the configuration of a base-station baseband unit employed in the embodiment of the present invention. A radiofrequency (RF) unit (RRH) is shown in FIG. 25. The baseband unit and RF unit are connected to each other via a common public radio interface (CPRI) interface.

In FIG. 24, a signal received by the RF unit is inputted from the left side of the drawing, and replaced with signals received through a digital input module IQ16 and multiple antennas by the CPRI interface (501). The converted signals each have a cyclic prefix (CP) removed therefrom in relation to each of the antennas by a CPE (502). The CP is a redundant signal to be inserted in order to improve the durability of an OFDM signal against a delay wave. The signals having the CPs removed therefrom are converted into frequency-domain information by a fast Fourier transformer (FFT) (503). The frequency-domain information is converted into a digital beam form by an SSP (504), and manipulated from information derived from antenna elements to information on beam elements. The manipulated information on beam elements is decomposed into channel elements, which are separated from one another at a resolution of a subcarrier of an OFDM symbol, by a demultiplexer (DMX) (505). The decomposition is called de-mapping. The de-mapped information includes a reference signal. The reference signal is transmitted to a CE (506), and used to infer a propagation path. The CE uses the reference signal to infer an interference wave sent from a terminal connected to a neighboring base station. The estimated propagation path is used to detect transmission data. The transmission data includes user data and control data. The control data is detected and decoded by a demodulator (DEM) (510), and passed to a digital signal processor (DSP) (509). The user data is subjected to maximum likelihood decoding by a maximum likelihood decoder (MLD) (507) using the estimated propagation path. The resultant log-likelihood ratio (LLR) is used to perform decoding by a decoder (DEC) (508). The result of the decoding is passed to the DSP (509). The DSP collects the result of channel estimation performed by the CE (506), the result of decoding of control data, and the result of decoding of user data, and transmits the user data over a network via a network interface. The result of channel estimation and the control information are stored in a memory (511), and used to control a packet scheduler constructed in the DSP. As for the control information, for example, a CQI to be reported by the terminal as mentioned in the flowchart of FIG. 13 (including an RI shown in FIG. 15 and others) is a form of control information.

In FIG. 25, signals received by multiple antennas (601) are separated into uplink signals and downlink signals by a duplexer (DUP) (602). The uplink signals are sent to a receiver (RX) (603). The RX (603) performs pieces of signal processing including signal amplification, frequency conversion, and digitization, and transmits a resultant signal to a CPRI interface (607). The CPRI interface (607) converts the signal to the one conformable to the CPRI format. The resultant signal is transmitted to the baseband unit indicated as port 0 in the drawing.

In FIG. 24, a downlink signal transmitted over the network is temporarily stored in the memory (511) of the DSP (509). A scheduler incorporated in the DSP (509) determines the transmission timing, a transmission beam, a transmission resource block, and a modulation scheme. The downlink signal is manipulated into a transmission signal according to the determination. First, user data stored in the memory (511) is subjected to channel coding by a channel coder (CC) (512). A signal resulting from the channel coding is converted into a modulated signal according to quaternary phase shift keying (QPSK) or the like by a modulator (MOD) (513). The modulated signal is subjected to mapping by a multiplexer (MUX) (517), or assigned to a subcarrier of an OFDM symbol. During the mapping, the reference signal produced by a RSG (516), and control channel information produced via a control-channel channel coder (CCHCC) (514) and a control channel modulator (CCHMOD) (515) are also assigned. The CCHCC (514) is a block that codes control information produced by the DSP (509), and the CCHMOD (515) is a block that modulates the coded control information. Frequency-domain information on beam elements mapped by the MUX (517) is array-weighted by an SSP (518), and converted into information derived from the antenna elements. The obtained frequency-domain information derived from the antenna elements is converted into a time-domain signal by an inverse fast Fourier transformer (519). The obtained time-domain signal is assigned a CP by a CPI (520), and converted into a CPRI interface by the CPRI interface (501), and transmitted to the RF unit (RRH).

### 7. Collaborative Actions of Base Stations for the ICIC Zone (Downlink)

As for the actions for the ICIC zone, a terminal has been described to report a wideband CQI, a DCQI, and a PSCI. In the embodiment of the present invention, aside from the PSCI, an un-preferred beam indicator (UPBI) is reported. A mechanism for collaboration between base stations on a downlink will be described. The UPBI represents an identifier of a beam that is sent from another base station and intensely interferes with a beam sent to a terminal. A period at intervals of which the UPBI is reported may be longer than the period at intervals which the other CQIs are reported.

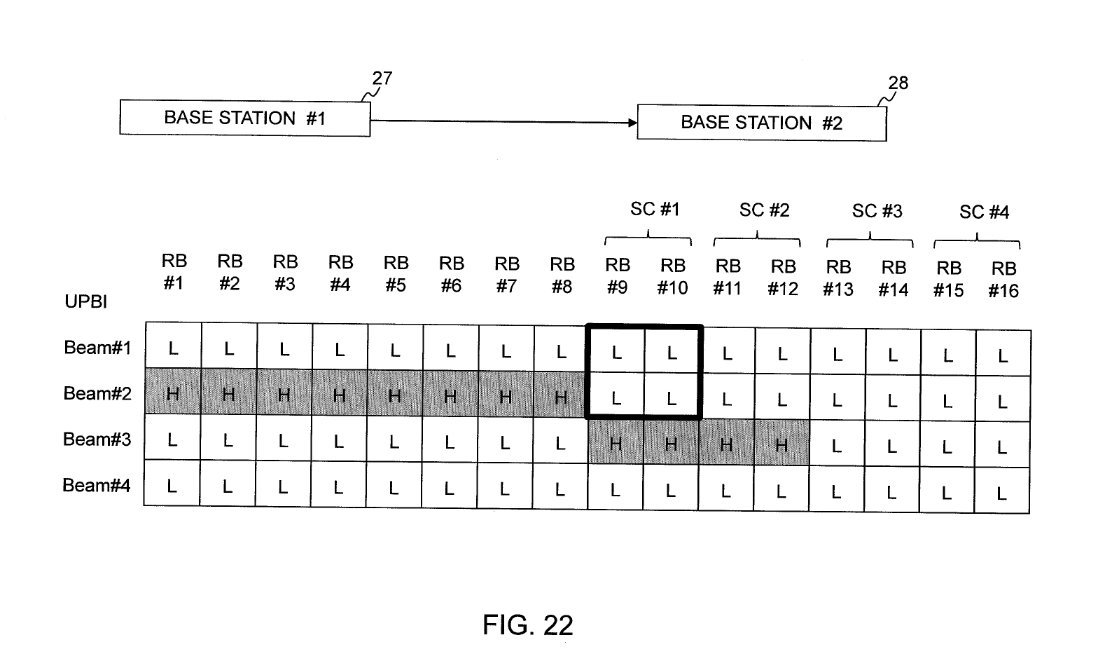

FIG. 22 is a diagram showing an inter-base station interface in the embodiment of the present invention.

A base station cumulates UPBIs, and notifies a neighboring station of the cumulated UPBIs using the inter-base station interface. FIG. 22 shows an example of a format for the UPBI to be transmitted from a terminal using the ICIC zone via the inter-base station interface. A base station 27 that transmits the UPBI transmits the UPBI while expecting a receiving-side base station 28 to cope with the UPBI. The UPBI is information on a matrix concerning beams and sub-channels. In the drawing, H signifies that an associated sub-channel and beam causes intense interference, and L signifies that an associated sub-channel and beam causes little interference. A neighboring base station having received the UPBI reflects the UPBI on scheduling, and decreases the frequency of channel allocation involving a beam and a sub-channel associated with a notification of H so that interference hardly occurs. For example, the beam is transmitted using another sub-channel instead of the above sub-channel. Thus, interference occurring between base stations can be reduced, and use efficiency of a channel can be improved. In the related art or an LTE system stipulated by the 3GPP, an indicator called HII is available in notifying that interference has occurred. The indicator HII indicates interference on an uplink. The UPBI is an indicator which a base station can, like the one in the embodiment of the present invention, produce when having a mechanism of collecting UPBIs from terminals. Although interference can conventionally be avoided through scheduling in the frequency domain, since interference can be notified with a resolution of each beam, scheduling for avoiding interference can be performed using a matrix of frequencies and beams. A higher effect can be provided.

To begin with, the usage of the ICIC zone will be described below. The ICIC zone relates to resource blocks RB#9 to RB#16 in the right part of FIG. 22.

Cumulation of UPBIs will be described. A base station has a memory block in which situations of interferences can be recorded in association with each beam, each resource block, and each neighboring base station concerned. One numerical value can be recorded in each rectangular area of the memory block. A terminal notifies a base station, to which the terminal is connected, of an identifier of a beam other than a beam being communicated, which causes intense interference, as a UPBI. In addition, the terminal notifies the base station of information on a sub-channel, which offers an excellent SINR, using a PSCI. The base station having been notified of the UPBI gives a fixed offset to a value in the memory block associated with a beam specified in the UPBI. For example, assume that the terminal reports a sub-channel #1 using the PSCI, and reports beams #1 and #2, which are sent from a certain neighboring base station, as the UPBI. In this case, an offset is added to numerical values recorded in an area in the memory block which is indicated with a bold line in the drawing and associated with the base station. This action is performed in relation to all terminals being connected, and finally the values in the memory block are multiplied by a fixed forgetting factor. If each of the obtained values in the memory block is higher than a predetermined specific value, interference caused by an associated beam and resource blocks is recognized as being intense. The information shown in FIG. 22 and having H specified therein is transmitted as the UPBI to the neighboring base station. The transmission is performed over a backbone constructed with wires.

Actions of a base station having received the UPBI will be described below. When allocating a resource block concerned, the base station having received the UPBI controls an evaluation function, for example, a proportional fairness evaluation function so that the resource block hardly be allocated by adding a negative offset to the resource block assigned to a beam concerned, and thus reduces traffic in the resource block. Thus, communication using a resource block that hardly causes interference is automatically achieved. Eventually, the aforesaid problem is solved.

Next, the usage of the non-ICIC zone will be described below. The non-ICIC zone relates to resource blocks RB#1 to RB#8 in the left part of FIG. 22.

Cumulation of UPBIs will be described. A base station has a memory block in which situations of interferences are, as shown in FIG. 22, recorded in association with each beam, each resource block, and each neighboring base station concerned. One numerical value can be recorded in each rectangular area in the memory block. A terminal reports a beam other than a beam being communicated, which causes intense interference, as a UPBI according to a situation. If the UPBI is reported, the base station adds an offset to numerical values recorded in the memory block in association with the beam and all the resource blocks included in the non-ICIC zone. This action is performed in relation to all terminals being connected. Finally, the values in the memory block are multiplied by a fixed forgetting factor. If the obtained values in the memory block are higher than a predetermined specific value, interferences caused by the associated beam and resource blocks are recognized as being intense. The information shown in FIG. 22 and having H specified therein is transmitted as the UPBI to the neighboring base station.

Actions of a base station having received the UPBI will be described. When allocating the resource blocks, the base station having received the UPBI controls an evaluation function, for example, a proportional fairness evaluation function so that a negative offset is added to the resource blocks associated with a beam concerned so that the resource blocks hardly be allocated. Thus, traffic in the resource blocks is reduced. Eventually, communication using a resource that hardly causes interference is automatically achieved. The aforesaid problem is solved.

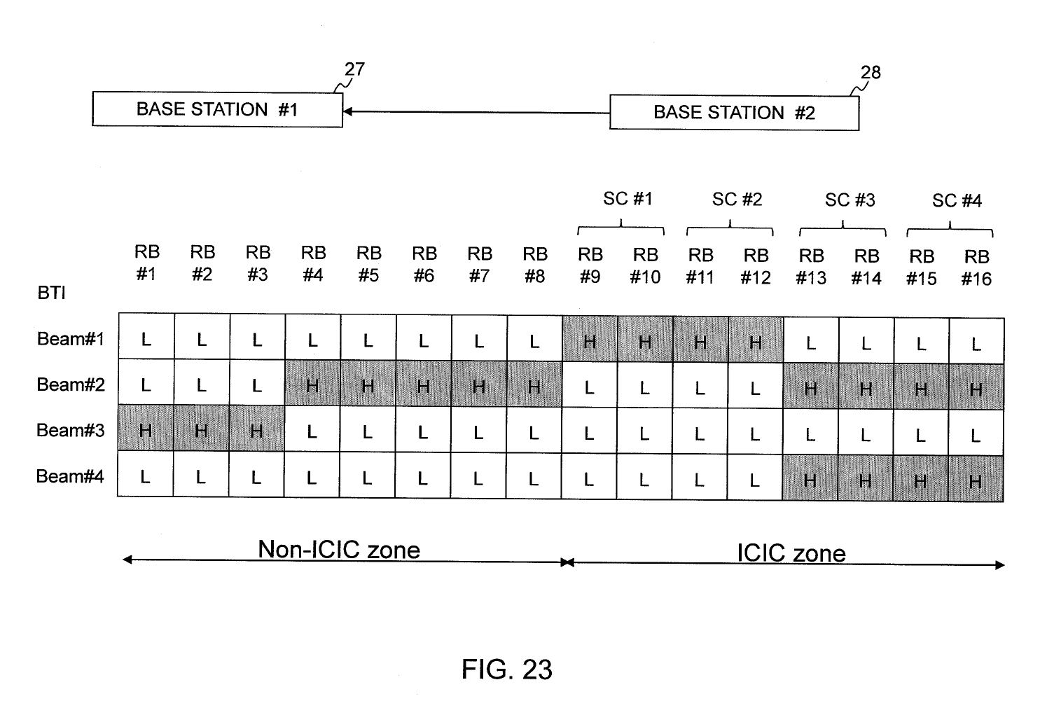

FIG. 23 is a diagram showing an inter-base station interface in the embodiment of the present invention.

As a mechanism of sharing scheduling information between base stations, a BTI shown in FIG. 23 may be exchanged. The BTI is an index representing a data transmission rate relevant to each sub-channel and each beam. Whether the data transmission rate is higher or lower than a threshold preset in a control device in a base station is decided. A rate at which data is assigned to a specific beam and a sub-channel concerned is measured. If the value is higher than the threshold, H is specified. If the value is lower, L is specified. The information is notified a neighboring base station. A scheduler in a base station that is a transmission source of the BTI acts to maintain the declared rate. If L is specified, a BTI receiving side recognizes that interference caused by the base station, sub-channel, and beam is limited, and performs scheduling. Using the BTI sent from the neighboring station, scheduling can be performed on the assumption that a possibility that a beam in a sub-channel specified to cause intense interference in a UPBI reported from the terminal may be transmitted is low. Therefore, use efficiency of a channel can be upgraded. For example, assume that a certain base station is discussing during packet scheduling to which of terminals A and B a signal should be first transmitted with a certain resource block allocated. The terminal A has undergone interference caused by a neighboring base station, and reports using a UPBI that a certain beam interferes with another. However, the BTI sent from the base station specifies L in relation to allocation of a resource block to the beam, that is, signifies that the allocation probability is low. In this case, high-speed data transfer based on a higher-speed modulation scheme may be performed, or a positive offset is added to an evaluation function, based on which a resource block is allocated to a beam to be directed to the terminal A, so that the resource can be readily allocated. Thus, communication can be performed by selecting a resource that little causes interference. Eventually, the aforesaid problem is solved.

In the related art, that is, an LTE system specified by the 3GPP, an indicator called an RNTP with which transmission power is notified is available. In the embodiment of the present invention, the idea of the indicator is expanded, and traffic is notified with a resolution of each beam instead of the power. The indicator RNTP is an indicator to be used as a dynamic FFR so that base stations can dynamically control a border between the ICIC zone and non-ICIC zone. The BTI in the embodiment is shared between base stations in order to learn in common which of resource blocks in a matrix of frequencies and beams is in a congested state and which of the resource blocks is in a sparse state. A scheduler in an information-receiving side base station uses the information to achieve scheduling with interference reliably avoided.

What is claimed is:

1. A wireless communication system including a plurality of base stations that transmit a plurality of beams with which a space is divided, wherein:
the base station splits a transmission frequency band into a first frequency band and a second frequency band;
in the first frequency band, the base station allocates beams to sub-channels or resource blocks, into which the first frequency band is further split, with the beams fixed to any pattern, on the basis of a beam schedule specifying a plurality of predetermined beams in association with each base station, and transmits signals; and
in the second frequency band, the base station allocates the beams to sub-channels or resource blocks, into which the second frequency band is further split, with the beams fixed to any pattern, on the basis of a beam schedule defined in accordance with communication traffic, and transmits signals.

2. The wireless communication system according to claim 1, wherein the base station decides, based on a situation of a propagation path reported from a terminal, whether the frequency to be used by the terminal falls within the first frequency band or the second frequency band, and instructs to change the reporting contents of communication quality information to be reported from the terminal.

3. The wireless communication system according to claim 1, wherein:
based on whether a first mode in which the frequency to be used by the terminal falls within the first frequency band or a second mode in which the frequency to be used by the terminal falls within the second frequency band is designated, the base station transmits a measurement report configuration, which includes the reporting contents of communication quality information on a reference signal sent from each base station and measured by the terminal, and a condition for a transition under which the first mode and the second mode are switched, to the terminal;
based on the measurement report configuration sent from the base station, the terminal sets the reporting contents of communication quality information and the condition for a transition, and, based on the setting, measures the reference signal sent from the base station so as to obtain the communication quality information according to whichever of the first mode and the second mode is designated, and reports the reporting contents of communication quality information to the base station;
based on whether the first mode or the second mode is designated for the terminal using the reporting contents sent from the terminal, the base station performs scheduling, and communicates with the terminal using either of the first frequency band and the second frequency band according to a result of the scheduling;
if the terminal decides that a result of measurement of the reference signal satisfies the condition for a transition specified in the measurement report configuration, the terminal reports a measurement report, which represents the result of measurement, to the base station;
on receipt of the measurement report, the base station decides that the terminal has made a transition between the first mode and the second mode;
the base station sets a new measurement report configuration specifying a reporting contents of communication quality information and a condition for a transition which are defined for the mode after a transition is made, and transmits the new measurement report configuration to the terminal;
based on the new measurement report configuration sent from the base station, the terminal sets the reporting contents of communication quality information and the condition for a transition, and, based on the setting, measures the reference signal sent from the base station so as to obtain the communication quality information according to whether the first mode or the second mode is designated, and reports the reporting contents of communication quality information to the base station; and
the base station performs scheduling in the mode after a transition is made, and communicates with the terminal using either of the first frequency band and the second frequency band according to a result of scheduling.

4. The wireless communication system according to claim 1, wherein:
in the first mode, the terminal reports, as the reporting contents, the communication quality information including a wideband communication quality indicator representing a mean signal-to-noise ratio in the first frequency band, a difference communication quality indicator representing a difference from a mean signal-to-nose ratio of a subcarrier exhibiting an excellent signal-to-noise ratio, and an excellent communication indicator signifying what is a sub-channel identifier or resource block identifier assigned to an excellent sub-channel or resource block; and
in the second mode, the terminal reports, as the reporting contents, the communication quality information including a wideband communication quality indictor representing a mean signal-to-noise ratio in the second frequency band, and an excellent beam indicator representing an excellent beam identifier.

5. The wireless communication system according to claim 2, wherein:
the second mode includes a low mode that is a mode to be designated when interference with another beam is smaller than a predetermined value, and a high mode that is a mode to be designated when interference with another beam is larger than a predetermined value;
the base station contains in the measurement report configuration a command with which a transition is made between the high mode in which a beam causing interference is pointed out, and the low mode in which the beam causing interference is not pointed out, in a cell center mode according to a situation of a propagation path reported from the terminal, and transmits the measurement report configuration to the terminal;
in the high mode, the terminal further reports a defective beam indicator, which specifies a beam causing interference larger than a predetermined value, as the reporting contents; and
as far as an interfering party lies in the own cell, the base station uses the received defective beam indicator to perform scheduling so that a beam specified in the excellent beam indicator representing an excellent beam identifier and a beam specified in the defective beam indicator are not allocated to the terminal using the same resource block.

6. The wireless communication system according to claim 1,
the base station comprises:
an inter-base-station interface in which interference information associated with each beam and each frequency is shared with a neighboring base station on the basis of information on a beam, which acts as an interference source, reported from the terminal, according to the situation of a propagation path reported from the terminal, and
a memory block in which situations of interferences relevant to each neighboring base station concerned are recorded in advance in association with each beam and each resource block;
wherein,
in the first mode, the terminal notifies the base station, to which the terminal is connected, of the defective indicator, which represents a beam identifier of a beam other than a beam being communicated, which is sent from another base station and that causes interference larger than a predetermined value to the terminal, and the excellent communication indicator representing a resource block that offers an excellent signal-to-noise ratio;
the base station having notified the defective beam indicator produces information representing on a situation of interference as a value in the memory block, which is designated with the resource block notified with the excellent communication indicator and the beam identifier specified designated in the defective beam indicator, and transmits the information to the neighboring base station; and
when computing allocation of resource blocks, the base station having received the information on the situation of interference refers the information to control the allocation of resource blocks so that a resource block causing interference larger than the predetermined value is hardly allocated, and thus reduces traffic in the resource block.

7. The wireless communication system according to claim 1,
the base station comprises:
an inter-base-station interface in which interference information associated with each beam and each frequency is shared with a neighboring base station on the basis of information on a beam, which acts as an interference source, reported from the terminal, according to the situation of a propagation path reported from the terminal, and
a memory block in which situations of interferences relevant to each neighboring base station concerned are recorded in advance in association with each beam and each resource block;
wherein,
in the second mode, the terminal notifies the base station to which the terminal is connected, of a defective beam indicator which represents a beam identifier of a beam other than a beam being communicated, which is sent from another base station and causes interference larger than a predetermined value to the terminal, and an excellent communication indicator representing a resource block that offers an excellent signal-to-noise ratio;
the base station having notified the defective beam indicator produces information representing on a situation of interference as a value in the memory block of the beam identifier associated with all or plural resource blocks included in the second frequency band, and transmits the information to the neighboring base station; and
when computing allocation of resource blocks, the base station having received the information on the situation of interference refers the information to control the allocation of resource blocks so that a resource block causing interference larger than the predetermined value is hardly allocated, and thus reduces traffic in the resource block.

8. The wireless communication system according to claim 1,
the base station comprises:
an inter-base station interface in which a transmission rate indicator representing a resource use rate or a data transmission rate in association with each beam and each frequency is used in common according to information on a packet schedule for allocating to beams, and
a memory block in which situations of interferences relevant to each neighboring base station concerned are recorded in advance in association with each beam and each resource block;
wherein
the base station decides for each beam and each frequency according to the information on the packet schedule, for allocating to beams, whether the resource use rate or data transmission rate is higher or lower than a predetermined threshold, produces a transmission rate indicator, and notifies the transmission rate indicator to a neighboring base station;
the base station that is a transmission source of the transmission rate indicator operates to maintain the notified resource use rate or data transmission rate; and
the base station that is a receiving side of the transmission rate indicator, when interference with a beam sent in a sub-channel or resource block concerned from a base station concerned is low, performs scheduling.

9. A wireless base station apparatus in a wireless communication system, the wireless base station apparatus which transmits a plurality of beams with which a space is divided, wherein:
the wireless base station apparatus splits a transmission frequency band into a first frequency band and a second frequency band;
in the first frequency band, the wireless base station apparatus allocates beams to sub-channels or resource blocks, into which the first frequency band is further split, with the beams fixed to any pattern, on the basis of a beam schedule specifying a plurality of predetermined beams in association with each base station, and transmits signals; and
in the second frequency band, the wireless base station apparatus allocates the beams to sub-channels or resource blocks, into which the second frequency band is further split, with the beams fixed to any pattern, on the basis of a beam schedule defined in accordance with communication traffic, and transmits signals.

10. A wireless communication method for a wireless communication system including a plurality of base stations that transmit a plurality of beams with which a space is divided, wherein:
the base station splits a transmission frequency band into a first frequency band and a second frequency band;
in the first frequency band, the base station allocates beams to sub-channels or resource blocks, into which the first frequency band is further split, with the beams fixed to any pattern, on the basis of a beam schedule specifying a plurality of predetermined beams in association with each base station, and transmits signals; and
in the second frequency band, the base station allocates the beams to sub-channels or resource blocks, into which the second frequency band is further split, with the beams fixed to any pattern, on the basis of a beam schedule defined in accordance with communication traffic, and transmits signals.

11. The wireless communication method according to claim 10, wherein the base station decides, based on a situation of a propagation path reported from a terminal, whether the frequency to be used by the terminal falls within the first frequency band or the second frequency band, and instructs to change the reporting contents of communication quality information to be reported from the terminal.

12. The wireless communication method according to claim 10, wherein:
based on whether a first mode in which the frequency to be used by the terminal falls within the first frequency band or a second mode in which the frequency to be used by the terminal falls within the second frequency band is designated, the base station transmits a measurement report configuration, which includes the reporting contents of communication quality information on a reference signal sent from each base station and measured by the terminal, and a condition for a transition under which the first mode and the second mode are switched, to the terminal;
based on the measurement report configuration sent from the base station, the terminal sets the reporting contents of communication quality information and the condition for a transition, and, based on the setting, measures the reference signal sent from the base station so as to obtain the communication quality information according to whichever of the first mode and the second mode is designated, and reports the reporting contents of communication quality information to the base station;
based on whether the first mode or the second mode is designated for the terminal using the reporting contents sent from the terminal, the base station performs scheduling, and communicates with the terminal using either of the first frequency band and the second frequency band according to a result of the scheduling;
if the terminal decides that a result of measurement of the reference signal satisfies the condition for a transition specified in the measurement report configuration, the terminal reports a measurement report, which represents the result of measurement, to the base station;
on receipt of the measurement report, the base station decides that the terminal has made a transition between the first mode and the second mode;
the base station sets a new measurement report configuration specifying a reporting contents of communication quality information and a condition for a transition which are defined for the mode often a transition is made, and transmits the new measurement report configuration to the terminal;
based on the new measurement report configuration sent from the base station, the terminal sets the reporting contents of communication quality information and the condition for a transition, and, based on the setting, measures the reference signal sent from the base station so as to obtain the communication quality information according to whether the first mode or the second mode is designated, and reports the reporting contents of communication quality information to the base station; and
the base station performs scheduling in the mode often a transition is made, and communicates with the terminal using either of the first frequency band and the second frequency band according to a result of scheduling.

13. The wireless communication method according to claim 10, wherein:
in the first mode, the terminal reports, as the reporting contents, the communication quality information including a wideband communication quality indicator representing a mean signal-to-noise ratio in the first frequency band, a difference communication quality indicator representing a difference from a mean signal-to-nose ratio of a subcarrier exhibiting an excellent signal-to-noise ratio, and an excellent communication indicator signifying what is a sub-channel identifier or resource block identifier assigned to an excellent sub-channel or resource block; and
in the second mode, the terminal reports, as the reporting contents, the communication quality information including a wideband communication quality indictor representing a mean signal-to-noise ratio in the second frequency band, and an excellent beam indicator representing an excellent beam identifier.

14. The wireless communication method according to claim 11, wherein:
the second mode includes a low mode that is a mode to be designated when interference with another beam is smaller than a predetermined value, and a high mode that is a mode to be designated when interference with another beam is larger than a predetermined value;
the base station contains in the measurement report configuration a command with which a transition is made between the high mode in which a beam causing interference is pointed out, and the low mode in which the beam causing interference is not pointed out, in a cell center mode according to a situation of a propagation path reported from the terminal, and transmits the measurement report configuration to the terminal;
in the high mode, the terminal further reports a defective beam indicator, which specifies a beam causing interference larger than a predetermined value, as the reporting contents; and
as far as an interfering party lies in the own cell, the base station uses the received defective beam indicator to perform scheduling so that a beam specified in the excellent beam indicator representing an excellent beam identifier and a beam specified in the defective beam indicator are not allocated to the terminal using the same resource block.

15. The wireless communication method according to claim 10,
the base station comprises:
an inter-base-station interface in which interference information associated with each beam and each frequency is shared with a neighboring base station on the basis of information on a beam, which acts as an interference source, reported from the terminal, according to the situation of a propagation path reported from the terminal, and
a memory block in which situations of interferences relevant to each neighboring base station concerned are recorded in advance in association with each beam and each resource block;
wherein,
in the first mode, the terminal notifies the base station, to which the terminal is connected, of the defective indicator, which represents a beam identifier of a beam other than a beam being communicated, which is sent from another base station and that causes interference larger than a predetermined value to the terminal, and the excellent communication indicator representing a resource block that offers an excellent signal-to-noise ratio;
the base station having notified the defective beam indicator produces information representing on a situation of interference as a value in the memory block, which is designated with the resource block notified with the excellent communication indicator and the beam identifier specified designated in the defective beam indicator, and transmits the information to the neighboring base station; and
when computing allocation of resource blocks, the base station having received the information on the situation of interference refers the information to control the allocation of resource blocks so that a resource block causing interference larger than the predetermined value is hardly allocated, and thus reduces traffic in the resource block.

16. The wireless communication method according to claim 10,
the base station comprises:
an inter-base-station interface in which interference information associated with each beam and each frequency is shared with a neighboring base station on the basis of information on a beam, which acts as an interference source, reported from the terminal, according to the situation of a propagation path reported from the terminal, and
a memory block in which situations of interferences relevant to each neighboring base station concerned are recorded in advance in association with each beam and each resource block;
wherein,
in the second mode, the terminal notifies the base station to which the terminal is connected, of a defective beam indicator which represents a beam identifier of a beam other than a beam being communicated, which is sent from another base station and causes interference larger than a predetermined value to the terminal, and an excellent communication indicator representing a resource block that offers an excellent signal-to-noise ratio;
the base station having notified the defective beam indicator produces information representing on a situation of interference as a value in the memory block of the beam identifier associated with all or plural resource blocks included in the second frequency band, and transmits the information to the neighboring base station; and
when computing allocation of resource blocks, the base station having received the information on the situation of interference refers the information to control the allocation of resource blocks so that a resource block causing interference larger than the predetermined value is hardly allocated, and thus reduces traffic in the resource block.

17. The wireless communication method according to claim 10,
the base station comprises:
an inter-base station interface in which a transmission rate indicator representing a resource use rate or a data transmission rate in association with each beam and each frequency is used in common according to information on a packet schedule for allocating to beams, and
a memory block in which situations of interferences relevant to each neighboring base station concerned are recorded in advance in association with each beam and each resource block;
wherein
the base station decides for each beam and each frequency according to the information on the packet schedule, for allocating to beams, whether the resource use rate or data transmission rate is higher or lower than a predetermined threshold, produces a transmission rate indicator, and notifies the transmission rate indicator to a neighboring base station;
the base station that is a transmission source of the transmission rate indicator operates to maintain the notified resource use rate or data transmission rate; and
the base station that is a receiving side of the transmission rate indicator, when interference with a beam sent in a sub-channel or resource block concerned from a base station concerned is low, performs scheduling.
